(19) United States
(12) Patent Application Publication
(10) Pub. No.: US 2026/0125966 A1
(43) Pub. Date: May 7, 2026

(54) FLOW CONTROL VALVE EMPLOYING AN ELECTRIC ACTUATOR AND METAL-TO-METAL SEAL

(71) Applicant: Halliburton Energy Services, Inc., Houston, TX (US)

(72) Inventors: Jonathon N. Joubran, Spring, TX (US); Sanjay Kanwarlal, Rio de Janeiro (BR); Samuel Amora Alves Neto, Rio de Janeiro (BR); Jefferson Koloda dos Santos, Rio de Janeiro (BR)

(21) Appl. No.: 19/379,591

(22) Filed: Nov. 4, 2025

Related U.S. Application Data
(60) Provisional application No. 63/716,557, filed on Nov. 5, 2024.

(51) Int. Cl. E21B 34/06

(52) U.S. Cl. CPC E21B 34/066; E21B 2200/06

(57) ABSTRACT

A flow control valve, a method and a well system. The flow control valve, in one aspect, includes a sliding sleeve disposed in a central bore of a housing, the sliding sleeve configured to move between a first state covering one or more flow trim ports and engaging a metal-to-metal seal and second state disengaging from the metal-to-metal seal and exposing at least a portion of the one or more flow trim ports. In accordance with one aspect, the flow control valve further includes an electric actuator coupled with the sliding sleeve, the electric actuator configured to move the sliding sleeve between the first state and the second state.

### CROSS-REFERENCE TO RELATED APPLICATION

This application claims the benefit of U.S. Provisional Application Serial No. 63/716,557, filed on November 5, 2024, entitled “ELECTRIC INTERVAL CONTROL VALVE WITH METAL TO METAL SEALING,” commonly assigned with this application and incorporated herein by reference in its entirety.

### BACKGROUND

The oil and gas services industry uses various types of downhole well devices or tools in well systems. For example, well systems typically include one or more downhole flow control valves, such as one or more interval control valves (ICVs). The one or more downhole flow control valves may be used to control the fluid flow to and from one or more wellbore zones of the well system.

### BRIEF DESCRIPTION

Reference is now made to the following descriptions taken in conjunction with the accompanying drawings, in which:

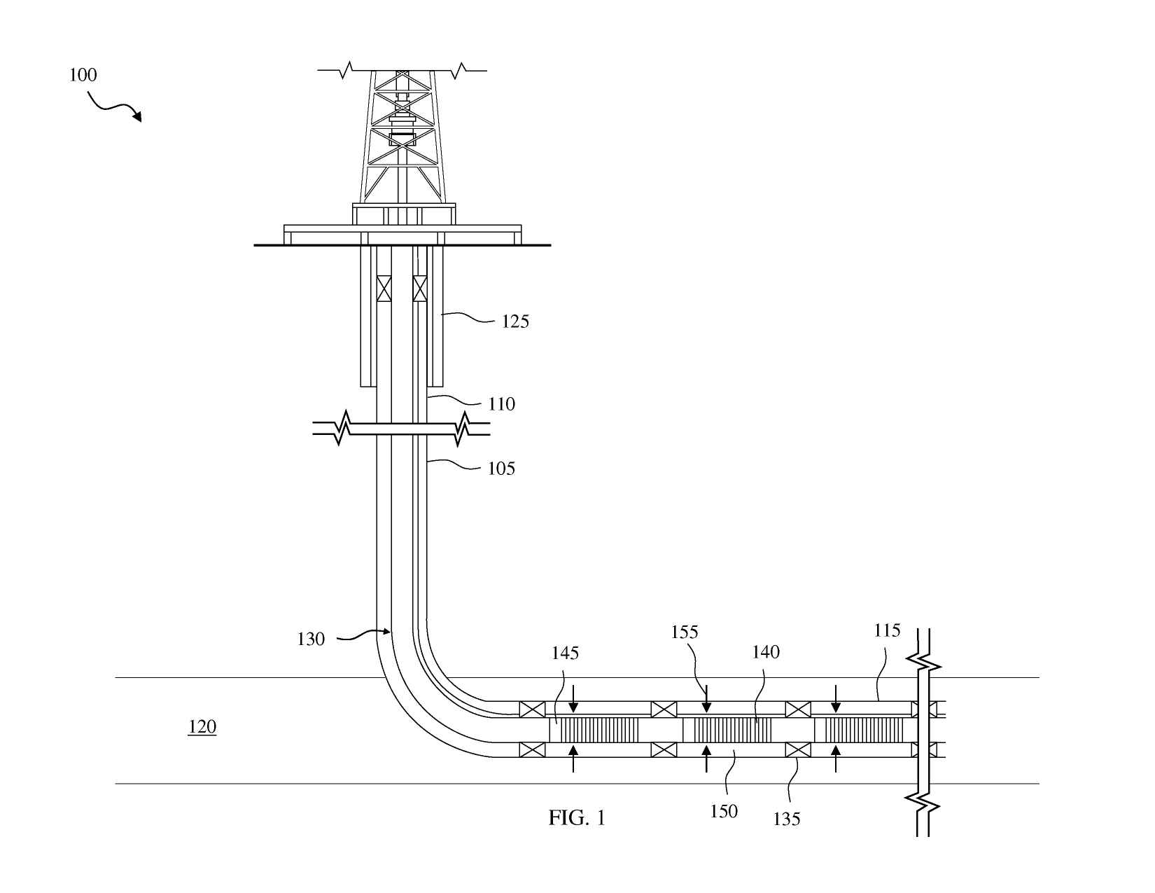

FIG. 1 is a well system designed, manufactured, and/or operated according to one or more embodiments of the disclosure;

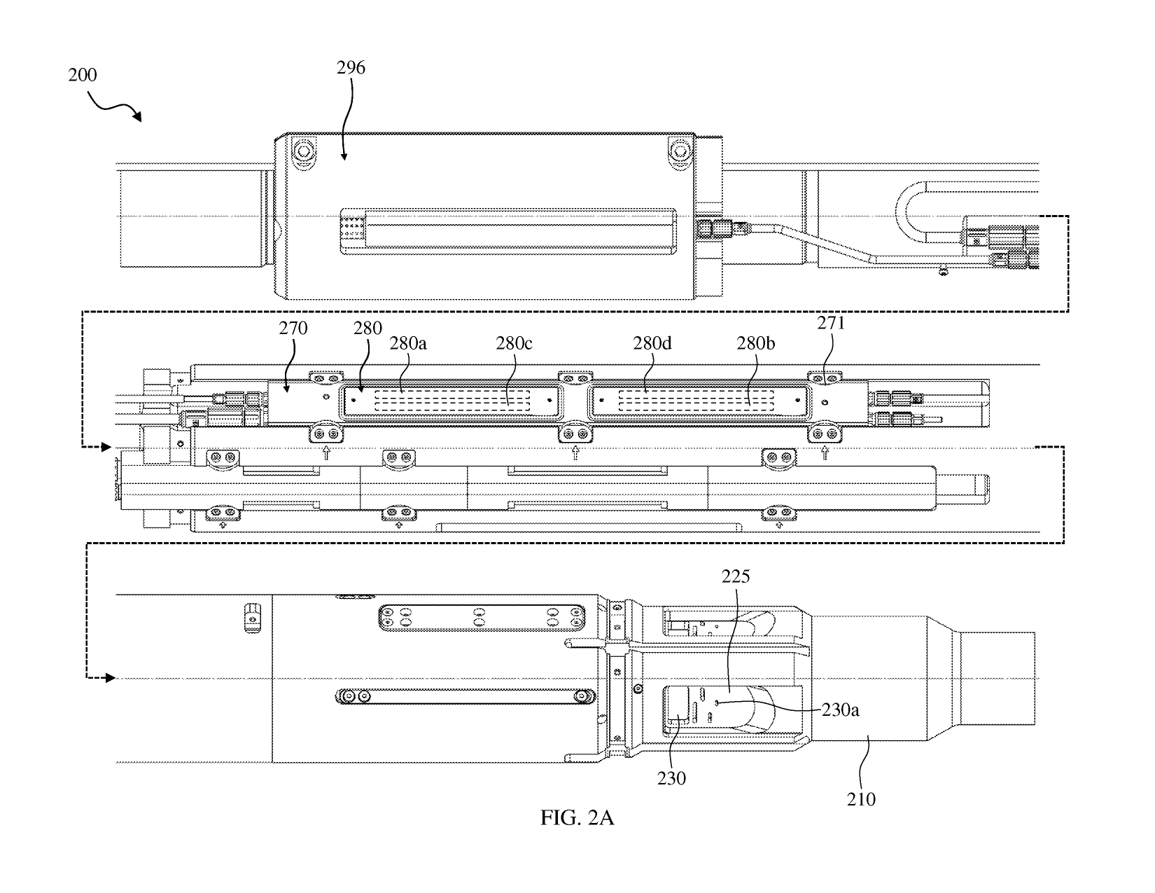

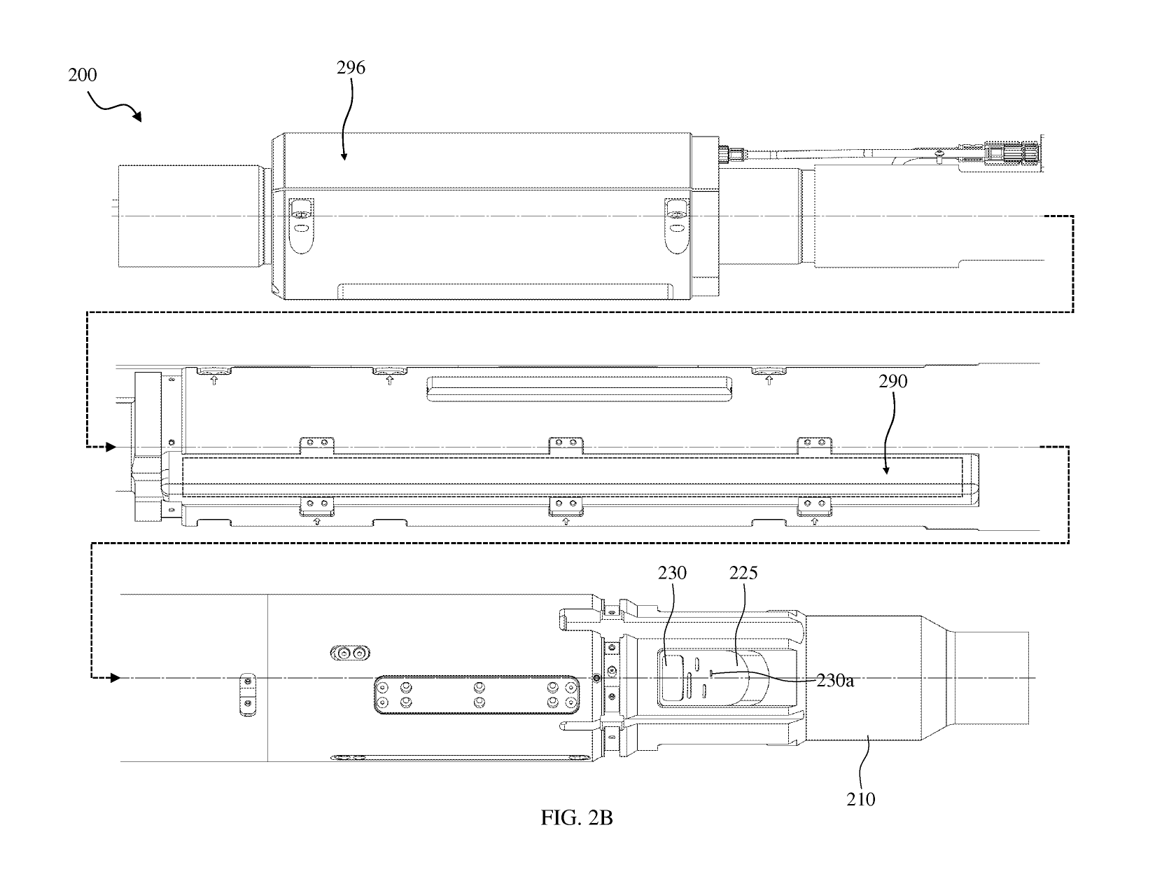

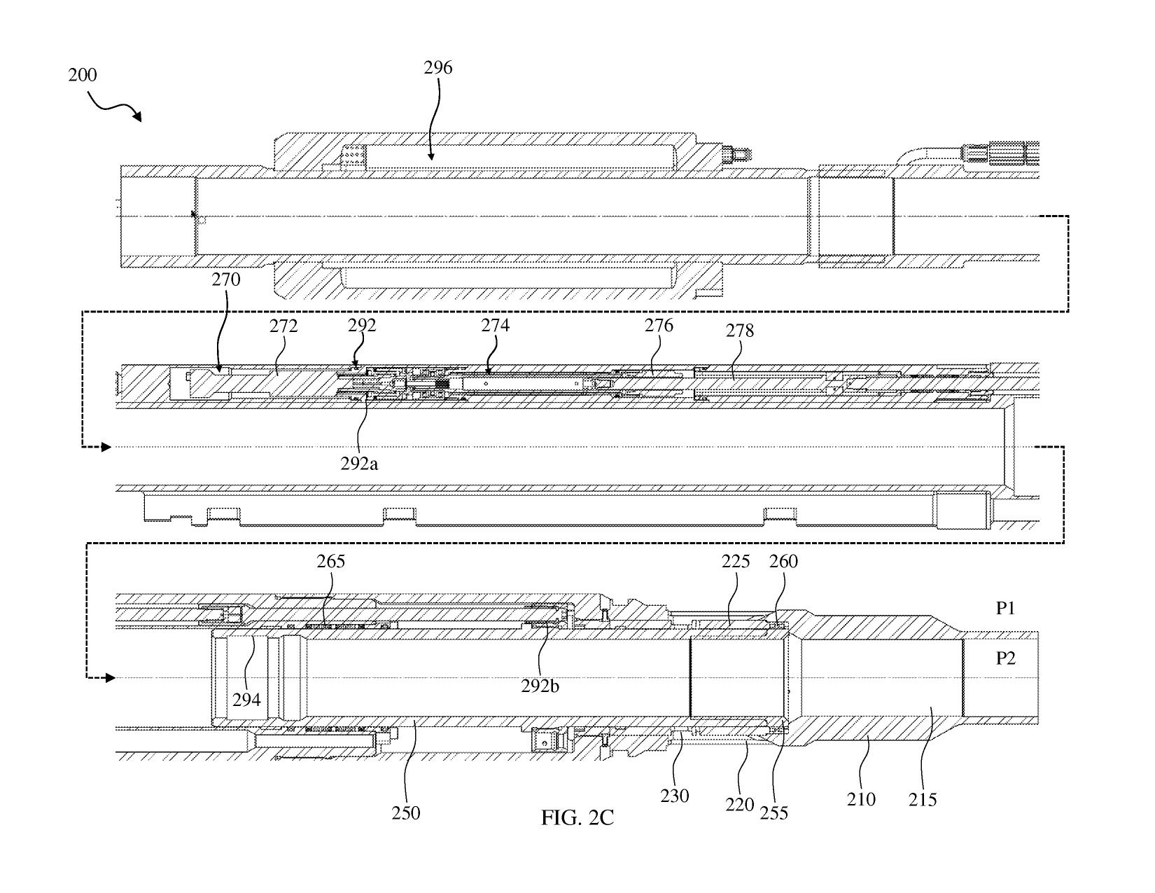

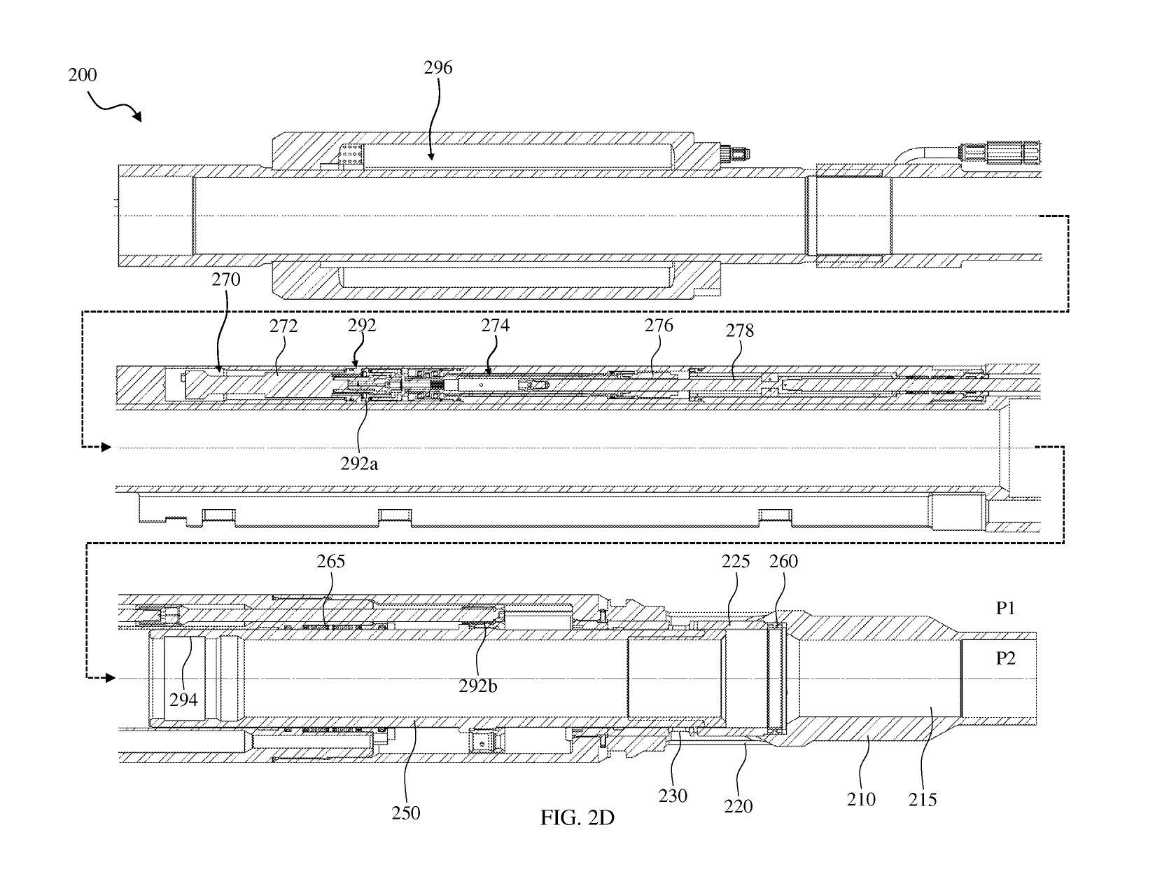

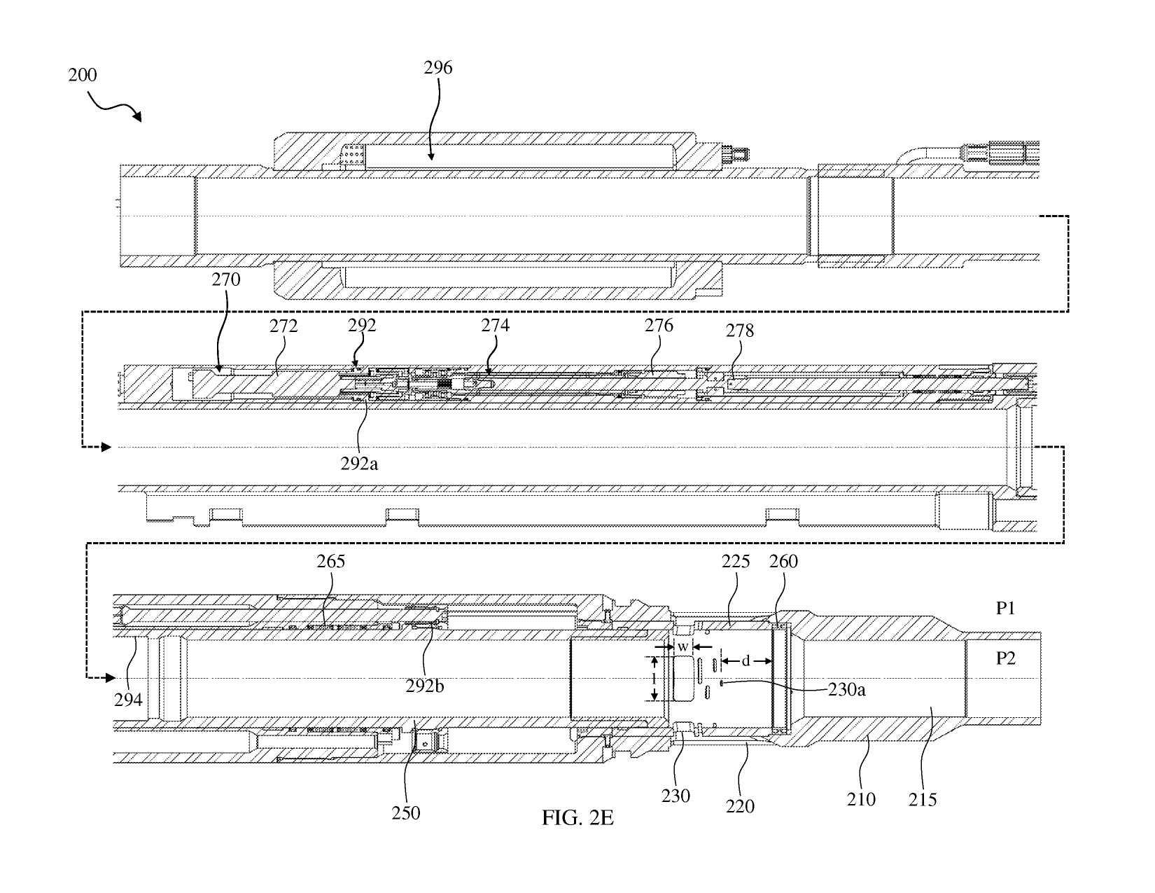

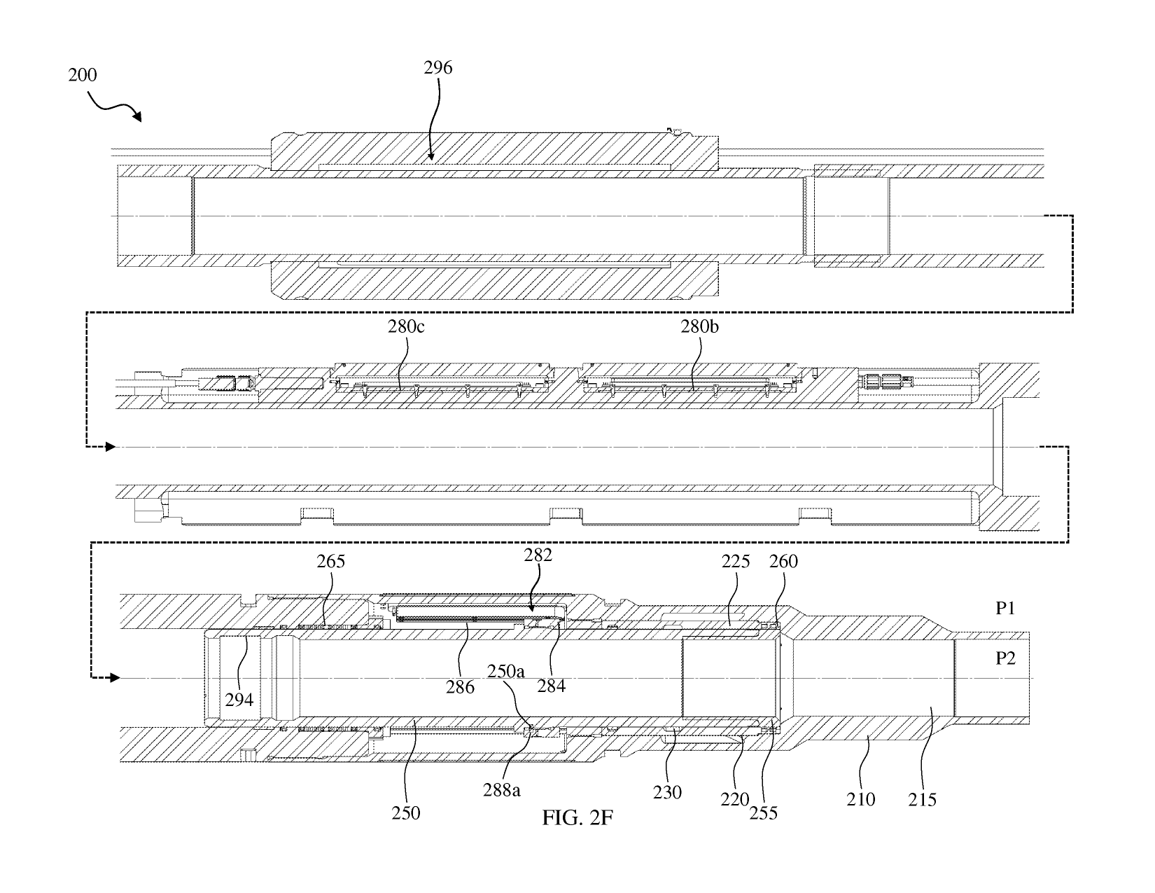

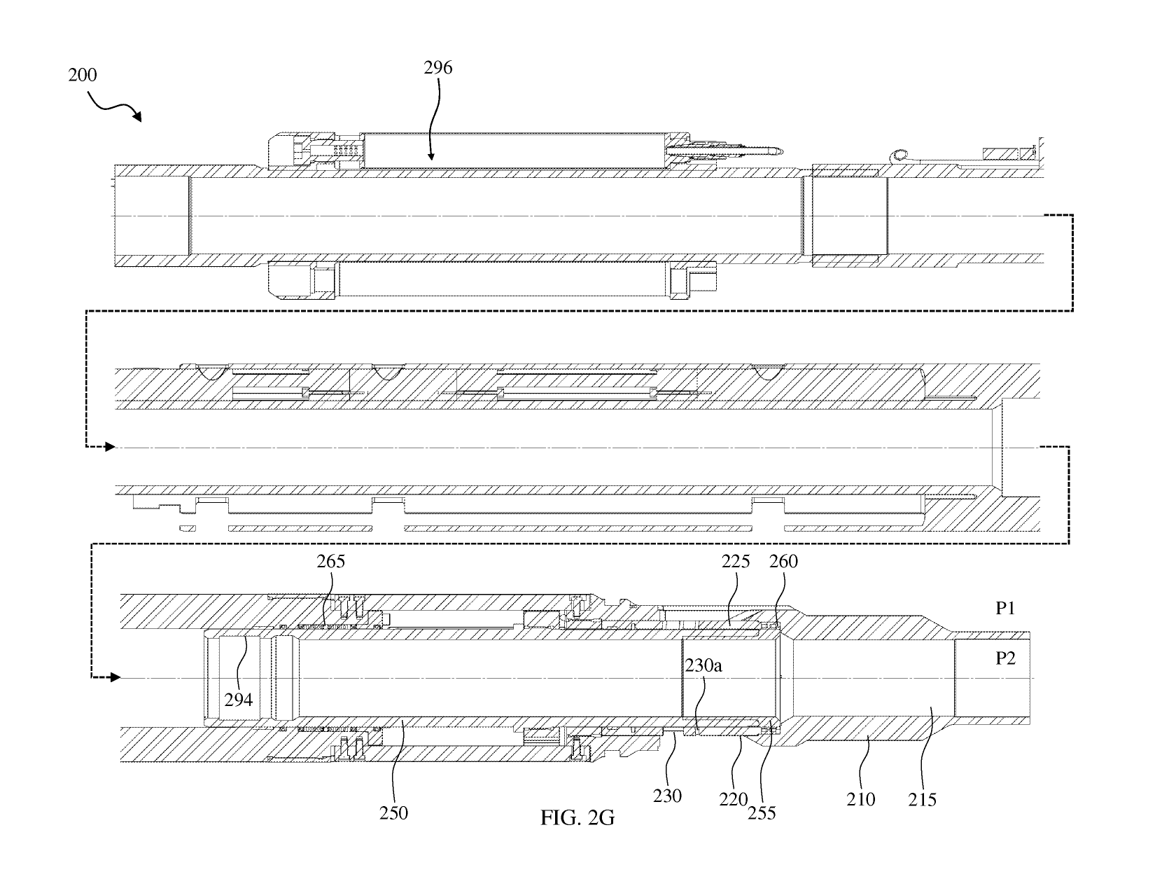

FIGS. 2A through 2G illustrate various different views of a flow control valve designed, manufactured, and/or operated according to one or more embodiments of the disclosure;

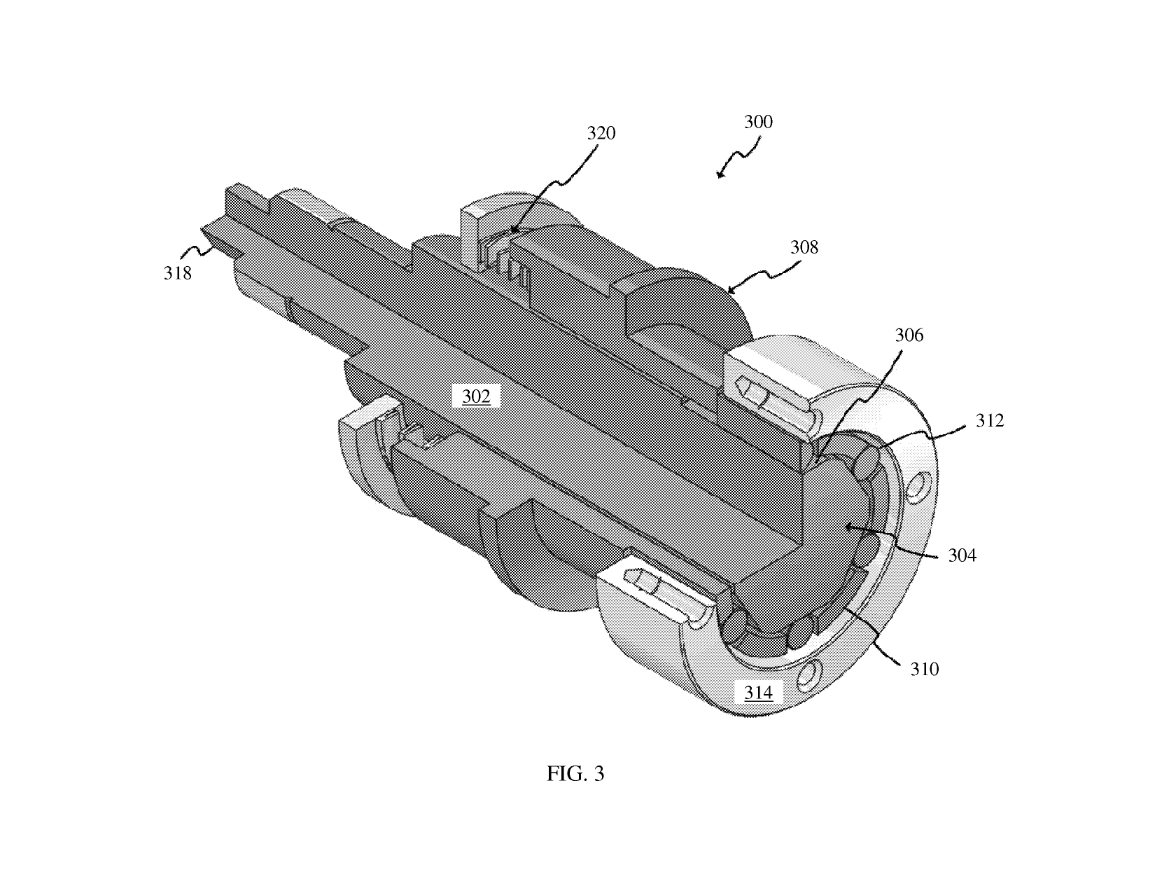

FIG. 3 illustrates a perspective, partial cutaway view of one embodiment of a bi-directional over-running clutch, according to some embodiments;

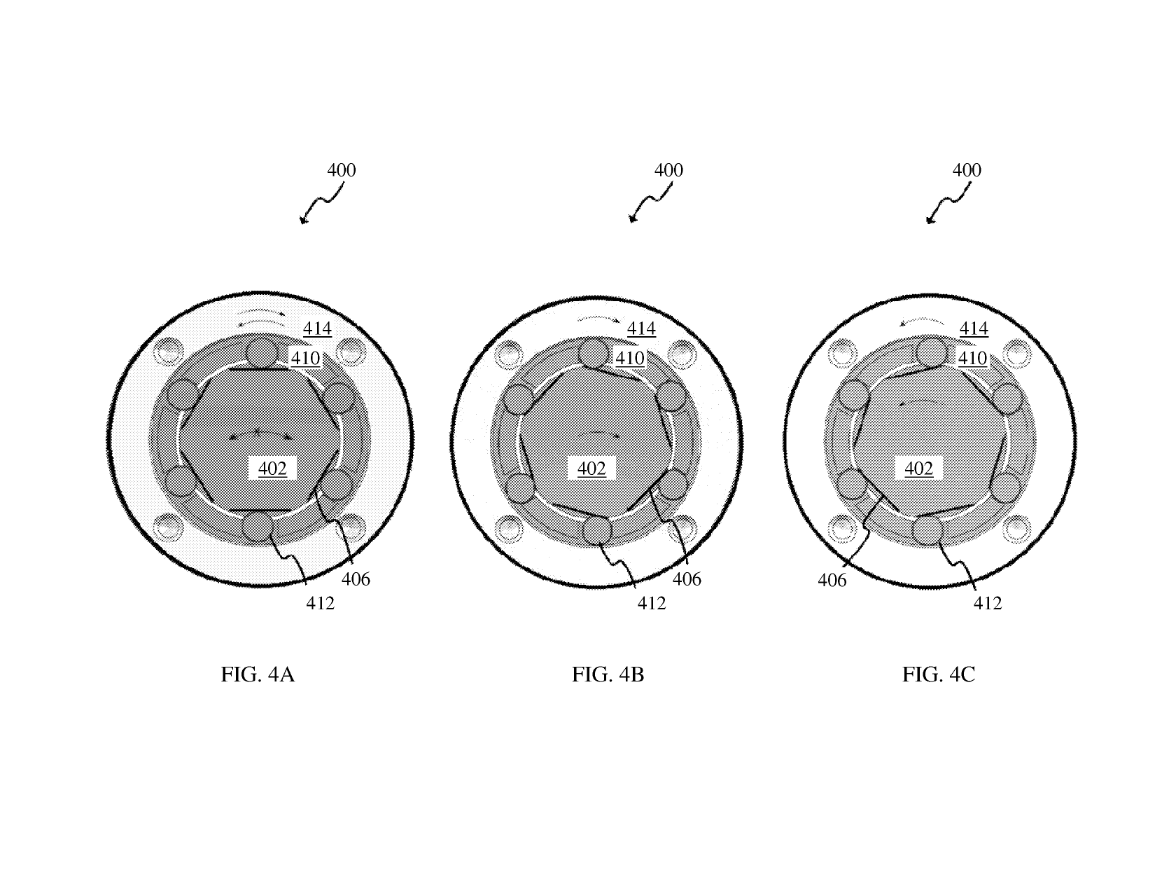

FIGS. 4A through 4C illustrate front views of one embodiment of a bi-directional over-running clutch shown in three positions, according to some embodiments;

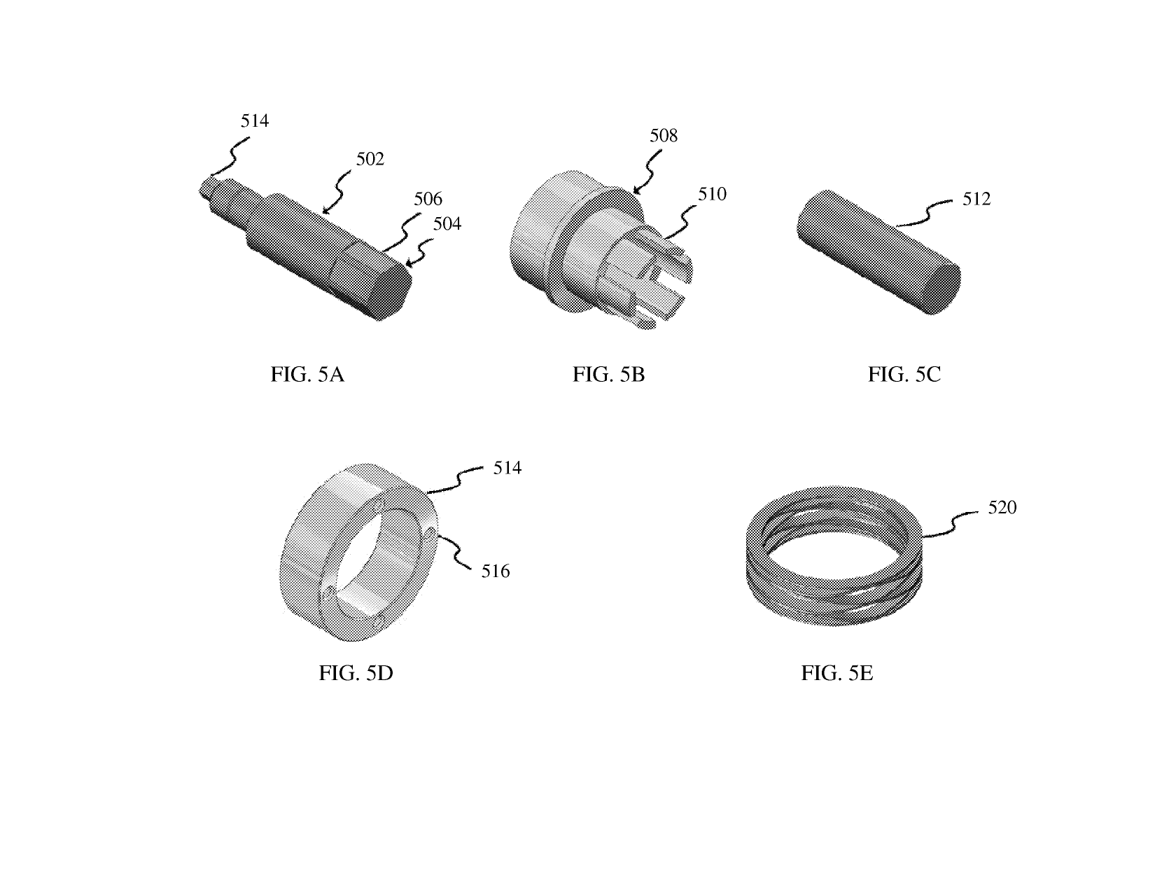

FIG. 5A through 5E illustrate perspective views of components of a bi-directional over-running clutch, according to some embodiments;

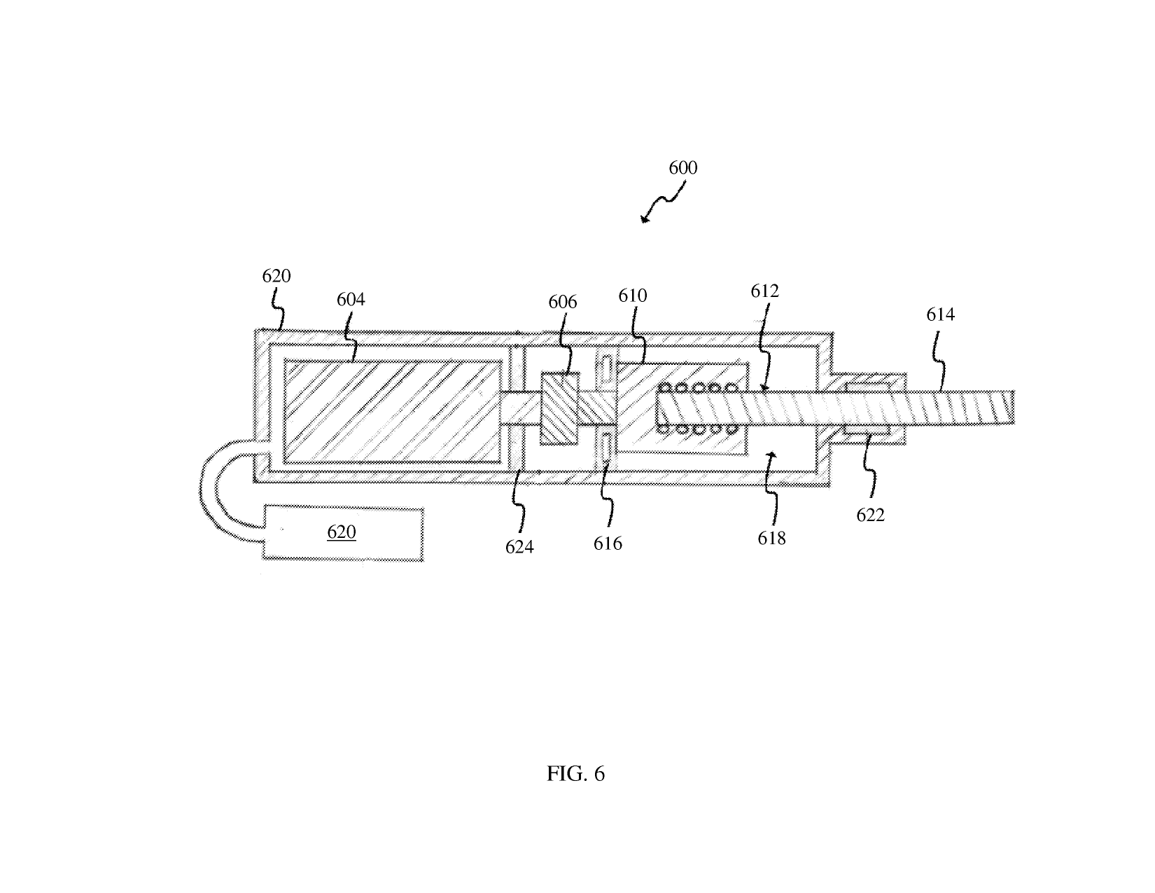

FIG. 6 illustrates a side section view of an electrical downhole backdrivable (EDB) actuator, according to some embodiments;

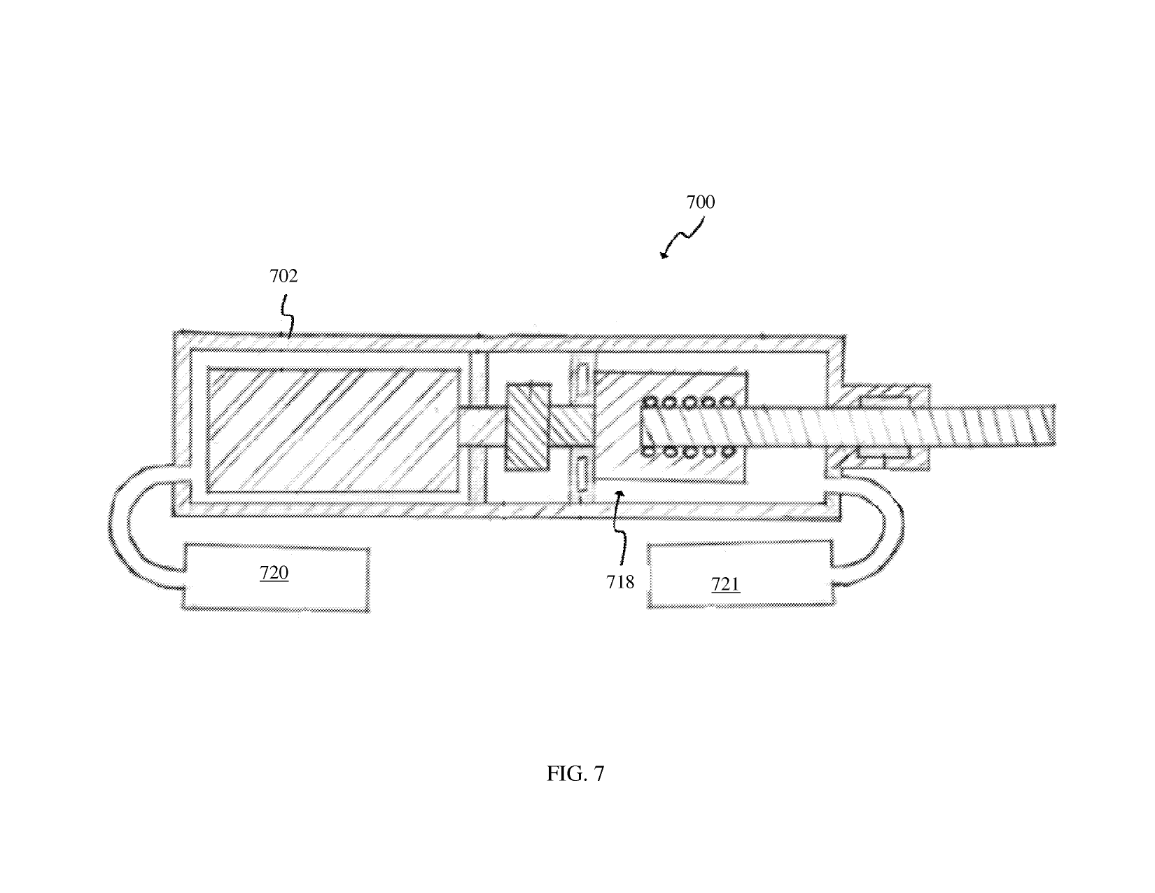

FIG. 7 illustrates a side section view of another embodiment of an EDB actuator;

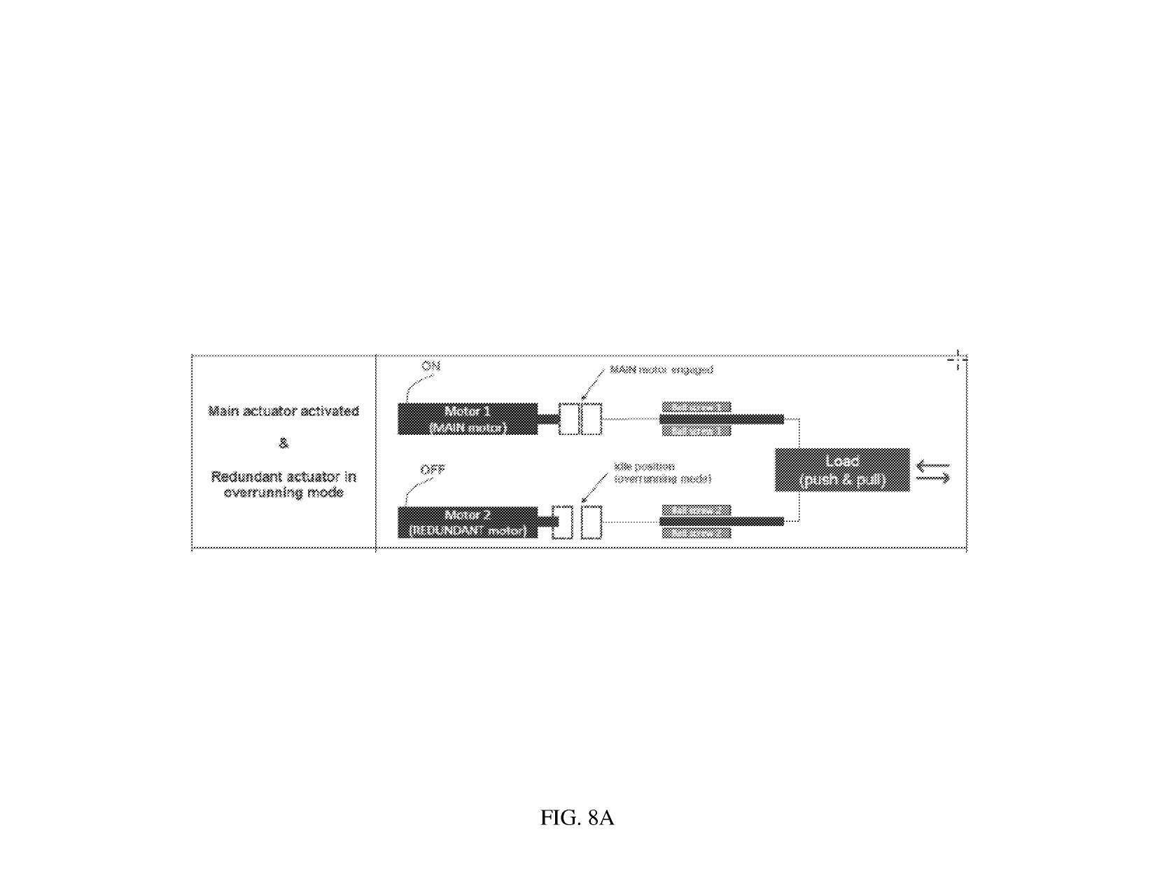

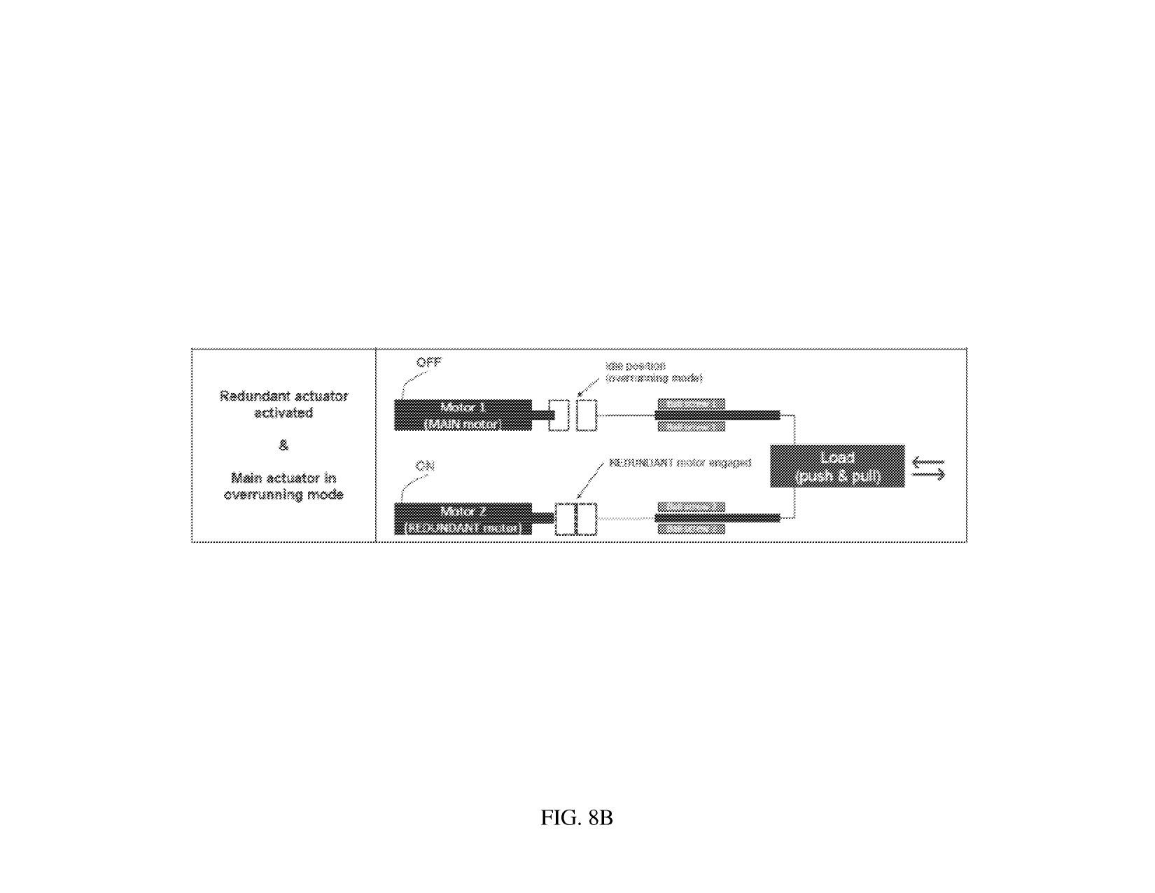

FIGS. 8A through 8B illustrate system diagrams illustrating different systems employing an EDB actuator and a clutch, according to some embodiments; and

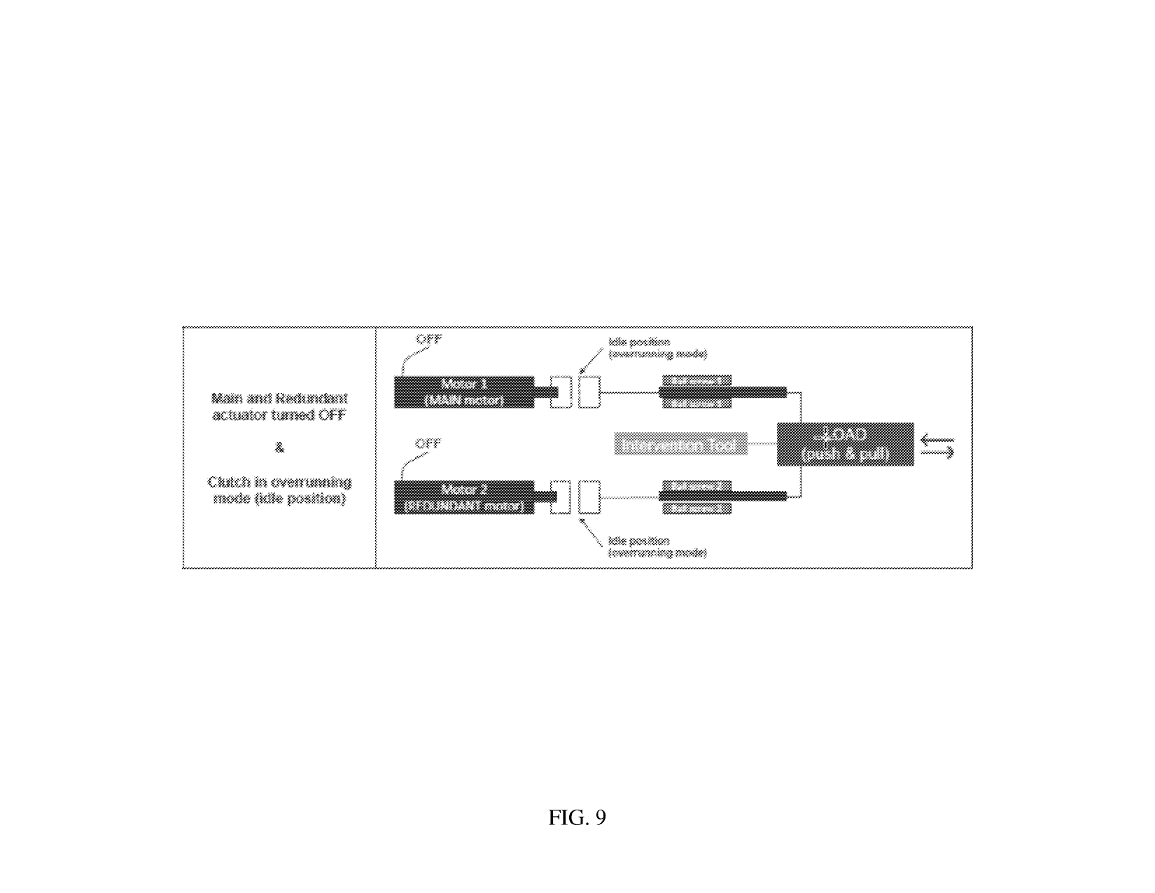

FIG. 9 illustrates a system diagram illustrating another system employing an EDB actuator and a clutch, according to some embodiments.

### DETAILED DESCRIPTION

In the drawings and descriptions that follow, like parts are typically marked throughout the specification and drawings with the same reference numerals, respectively. The drawn figures are not necessarily to scale. Certain features of the disclosure may be shown exaggerated in scale or in somewhat schematic form and some details of certain elements may not be shown in the interest of clarity and conciseness. The present disclosure may be implemented in embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed herein may be employed separately or in any suitable combination to produce desired results.

Unless otherwise specified, use of the terms “connect,” “engage,” “couple,” “attach,” or any other like term describing an interaction between elements is not meant to limit the interaction to direct interaction between the elements and may also include indirect interaction between the elements described. Furthermore, unless otherwise specified, use of the terms “up,” “upper,” “upward,” “uphole,” “upstream,” or other like terms shall be construed as generally toward the surface of the subterranean formation; likewise, use of the terms “down,” “lower,” “downward,” “downhole,” “downstream,” or other like terms shall be construed as generally toward the bottom, terminal end of a well, regardless of the wellbore orientation. Use of any one or more of the foregoing terms shall not be construed as denoting positions along a perfectly vertical axis. Additionally, unless otherwise specified, use of the term “subterranean formation” shall be construed as encompassing both areas below exposed earth and areas below earth covered by water such as ocean or fresh water.

Various values and/or ranges are explicitly disclosed in certain embodiments herein. However, values/ranges from any lower limit may be combined with any upper limit to recite a range not explicitly recited. Similarly, values/ranges from any lower limit may be combined with any other lower limit to recite a range not explicitly recited. In the same way, values/ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited. Similarly, an individual value disclosed herein may be combined with another individual value or range disclosed herein to form another range.

The term “substantially XYZ,” as used herein, means that it is within 10 percent of perfectly XYZ. The term “significantly XYZ,” as used herein, means that it is within 5 percent of perfectly XYZ. The term “ideally XYZ,” as used herein, means that it is within 1 percent of perfectly XYZ. The monicker “XYZ” could refer to parallel, perpendicular, alignment, or other relative features disclosed herein.

The present disclosure has acknowledged that well system operators are now desiring/requiring electrically actuated downhole flow control valves (e.g., downhole interval control valves (ICV's)) to reduce costs and complexity associated with hydraulically operated flow control valves. The present disclosure employs many of the specifics of a hydraulically actuated flow control valve with proven track history, but in one or more embodiments employs an electric actuator (e.g., and moveable feature) that is configured to engage with a metal-to-metal seal. With an electric actuator mounted on the outside of the flow control device, a sliding sleeve thereof can then be actuated electrically (e.g., rather than or in combination to). The outside housing can also have sensors, such as pressure and temperature. Also, redundant electronics and actuators may be employed. The flow control valve including the electric actuator, in certain embodiments, may use a single conductor (e.g., single “tubing encapsulated conductor” (TEC)) for power and control of the flow control valve itself, as well as multiple flow control valves may be daisy chained together using the same single conductor.

Thus, in at least one embodiment, the present disclosure employs a metal-to-metal tubing to annular seal. In at least one embodiment, the present disclosure also employs a tungsten carbide choke and/or a tungsten carbide tipped sleeve. In at least one embodiment, a position (e.g., of the sliding sleeve) may be determined using one or more of a dedicated position sensor (e.g., resistivity based position sensors) and/or motor turns. The present disclosure may additionally employ a network interface unit, redundancy, the ability to shroud with sand screens, and a pressure compensation system. The present disclosure may additionally provide the ability to decouple the actuator via a decoupling mechanism (e.g., when mechanically shifting the sliding sleeve and/or employing a second actuator to shift the sliding sleeve), where afterwords the actuation system could still move the sliding sleeve. The present disclosure may additionally provide bi-directional movement of the sliding sleeve to and from open, closed and an unlimited number of various choke positions located therebetween.

In at least one embodiment, the device is a permanently installed downhole flow control valve employing an electric actuator and a metal-to-metal seal (e.g., tubing to annular and /or annulus to tubing seal). The flow control valve may be actuated via an electric actuator, which may include an electric motor and a transmission (e.g., configured to convert the rotational motion of the electric motor to translation motion of the sliding sleeve) such as a ball screw and rod. The actuation system may be mounted on the outside of the housing of the flow control valve, and may include in one or more embodiments fully redundant motor/actuator/electronics. The flow control valve including the electric actuator, in one or more embodiments, may include a decoupling mechanism that allows the electric actuator to decouple (e.g., and potentially recouple) with the sliding sleeve, for example if it were necessary to mechanically manipulate the sliding sleeve with a shifting tool or manipulate the sliding sleeve with a second (e.g., redundant but separately operable) actuator. Again, in one or more embodiments, the electric actuator may recouple with the sliding sleeve and regain integrity after the secondary shifting operation. The electric actuator, in one or more embodiments, may additionally include actuator electronics associated therewith, the actuator electronics including one or more of a network interface unit module, a power supply module, and a motor control module, whether formed as the same or separate modules, and whether or not formed a part of one or more integrated circuit chips. The actuator electronics, in one or more embodiments, may further include a noise filter module configured to filter electronic noise created by the operation of the flow control valve that would otherwise disrupt an accuracy of an electronic sensor (e.g., the position sensor) that may be used. In at least one embodiment, the power consumption for a given flow control valve is less than or equal to 96 watts from surface, if not less than or equal to 90 watts from surface, if not less than or equal to 85 watts from surface.

The flow control valve can have integrated sensors mounted to it and connected into the network interface unit module. The sensors may be various pressure, temperature, water, gas composition, vibration sensors, among other known or hereafter discovered sensors. Multiple flow control valves (e.g., flow control valves employing an electric actuator, whether alone or in combination with the aforementioned metal-to-metal seal, the at least a 1.5 KSI pressure differential between an outside of the housing (P1, such as at the annulus) and the central bore (P2, such as at the tubing), the resistance based position sensor, and the first and second independently operated actuators), in one or more embodiments, can be installed using one single conductor (e.g., TEC to surface).

FIG. 1 illustrates a schematic view of a well system designed, manufactured, and/or operated according to one or more embodiments of the disclosure. The well system 100 may include a wellbore 105 that comprises a generally vertical uncased section 110 that may transition into a generally horizontal uncased section 115 extending through a subterranean formation 120. In some examples, the vertical uncased section 110 may extend downwardly from a portion of wellbore 105 having a string of casing 125 cemented therein. A tubular string, such as production tubing 130, may be installed in or otherwise extend into wellbore 105.

In the illustrated embodiment, one or more production packers 135, one or more well screens 140, and one or more downhole flow control valves 145 (e.g., flow control valves employing an electric actuator) may be interconnected along the production tubing 130. In most systems, there are at least two sets of production packers 135, well screens 140, and downhole flow control valves 145 (e.g., flow control valves employing an electric actuator) interconnected along the production tubing 130. The production packers 135 may be configured to seal off an annulus 150 defined between the production tubing 130 and the walls of wellbore 105. As a result, fluids 155 may be produced from multiple intervals of the surrounding subterranean formation 120, in some embodiments via isolated portions of annulus 150 between adjacent pairs of production packers 135 and through the downhole flow control valves 145. The well screens 140 may be configured to filter fluids 155 flowing into production tubing 130 from annulus 150 and downhole flow control valves 145. Each of the one or more downhole flow control valves 145, in one or more embodiments, may be designed according to one or more of the embodiments disclosed herein.

Turning to FIGS. 2A through 2G, illustrated are various different views of a flow control valve 200 designed, manufactured, and/or operated according to one or more embodiments of the disclosure. FIGS. 2A and 2B illustrate different exterior side views of the flow control valve 200 at different angles of rotation, whereas FIGS. 2C through 2G illustrate different cross-sectional views of the flow control valve 200 illustrated in FIGS. 2A and 2B to show different internal features thereof.

Notwithstanding, in one or more embodiments, the flow control valve 200 of FIGS. 2A through 2G includes a housing 210 including a central bore 215 extending axially there through. In or more embodiments, the housing 210 is a metal housing and the central bore 215 is an axial bore configured to convey subsurface fluids there through. In the illustrated embodiments, an opening 220 (e.g., window in one embodiment) is located in a sidewall of the housing 210. For example, in at least one embodiment, the opening 220 is a first opening, and the housing 210 includes two or more additional openings 220 in the housing 210. In at least one embodiment, for example when the housing 210 includes two or more openings 220, the two or more openings 220 are positioned substantially equidistance around the housing 210. Thus, if for example the housing 210 were to include two openings 220, the two openings 220 would be positioned substantially 180 degrees from one another. Alternatively, if the housing 210 were to include three openings 220, the three openings would be positioned substantially 120 degrees from one another, and so on and so forth.

In at least one embodiment, the flow control valve 200 further includes a flow trim 225 coupled with the housing 210 and covering the opening 220. In at least one embodiment, the flow trim 225 is a single flow trim 225 covering the opening 220 (e.g., one or more openings 220). In yet another embodiment, the flow trim 225 is a plurality of discrete flow trim portions that cover the opening 220 (e.g., one or more openings). For example, in one or more embodiments, the flow trim 225 includes an equal number of flow trim portions as the housing 210 includes openings 220.

In at least this one embodiment, the flow trim 225 includes one or more flow trim ports 230 configured to allow the subsurface fluids to pass between the housing 210 and a subterranean formation surrounding the housing 210. In at least one other embodiment, the flow control valve 200 further includes a sliding sleeve 250 disposed in the central bore 215 of the housing 210. In this one embodiment, the sliding sleeve 250 is configured to move between a first state (e.g., FIGS. 2C, 2F and 2G) covering the one or more flow trim ports 230 and engaging a housing seal 260 (e.g., metal-to-metal housing seal), and a second state (e.g., FIGS. 2D and 2E) disengaging from the housing seal 260 (e.g., metal-to-metal housing seal) and exposing at least a portion of the one or more flow trim ports 230. In at least one other embodiment, a second seal 265 (e.g., a second elastomeric seal, such as a second elastomeric chevron seal) is located more near an opposite end of the sliding sleeve 250 than the housing seal 260. In at least this one embodiment, the second seal 265 is a dynamic seal that allows the sliding sleeve 250 to slide there past, while continuing to seal.

In one or more embodiments, the sliding sleeve 250 is a metal sliding sleeve 250 having a hardness. In yet another embodiment, the sliding sleeve 250 includes a sliding sleeve tip 255 having a greater hardness. For example, in at least one embodiment, the sliding sleeve tip 255 is a carbide sliding sleeve tip 255 that is configured to improve/reduce an amount of wear or erosion on the sliding sleeve 250, for example as the sliding sleeve 250 moves (e.g., repeatedly moves) between the first and second states. In at least one embodiment, the sliding sleeve 250 and the sliding sleeve tip 255 are shrunk fit together. In at least one embodiment, the sliding sleeve tip 255 is a sliding sleeve nose and could be positioned end to end with the sliding sleeve 250, positioned within the sliding sleeve 250 (e.g., as an insert), or positioned about the sliding sleeve 250, among other configurations.

In at least one embodiment, the housing seal 260 is a metal-to-metal seal. I this embodiment, the metal-to-metal seal forms a metal-to-metal coupling between the housing 210 and the sliding sleeve 250 to achieve the appropriate seal. In at least one embodiment, such as that shown, the metal-to-metal seal is an interference fit metal-to-metal seal (e.g., depending on the orientation, either an H-shaped or I-shaped interference fit metal-to-metal seal in one embodiment). In at least one other embodiment, the interference fit metal-to-metal seal includes one or more seal nubs located on an interior radial surface thereof, the one or more seal nubs configured to engage with the sliding sleeve 250 when the sliding sleeve is in the first state. In yet another embodiment, the interference fit metal-to-metal seal includes one or more second seal nubs located on an exterior radial surface thereof, the one or more second seal nubs configured to engage with the housing 210 when the sliding sleeve 250 is in the first state.

In at least one embodiment, a size or position of the one or more flow trim ports 230 are configured to prevent the housing seal 260 (e.g., metal-to-metal housing seal) from eroding while providing at least a 1.5 KSI pressure differential between an outside of the housing 210 (P1, such as the annulus) and the central bore 215 (P2, such as the tubing) as the sliding sleeve 250 moves past a nearest most flow trim port 230a to the housing seal 260 (e.g., metal-to-metal housing seal). In at least one other embodiment, the one or more flow trim ports 230 are configured to prevent the housing seal 260 (e.g., metal-to-metal housing seal) from eroding while providing at least a 2.0 KSI pressure differential. In even yet one other embodiment, the one or more flow trim ports 230 are configured to prevent the housing seal 260 (e.g., metal-to-metal housing seal) from eroding while providing at least a 2.5 KSI pressure differential, if not at least 3.0 KSI pressure differential.

To validate the long-term erosion resistance of the flow control valve 200 under representative downhole conditions, an erosion qualification test was conducted to simulate 27 years of field service life. The objective was to assess the structural and sealing integrity of the flow control valve 200 under two key flow configurations—fully open and intermediate positions—while maintaining the aforementioned pressure differentials above (e.g., at least a 1.5 KSI pressure differential, at least a 2.0 KSI pressure differential, at least a 2.5 KSI pressure differential and at least a 3.0 KSI pressure differential discussed above. The acceleration factor for the test was derived from the sand/solids concentration in the slurry. To achieve life equivalence within a practical test duration, the sand/solids volume was increased by 3 % relative to expected field conditions. This controlled acceleration allowed the total test exposure of 86 hours to replicate the cumulative erosive effect expected over a 27-year downhole operating period. Of the total exposure time, 69 hours were conducted with the valve in the fully open position (e.g., representing the primary production flow condition) and 17 hours were conducted with the valve in the intermediate position, corresponding to the throttling condition with the aforementioned pressure differentials.

Based on erosion modeling and the proportional exposure under accelerated sand/solids volume, the flow condition experienced during the intermediate phase equates to approximately 5 – 6 years of continuous pressure differential operation under downhole conditions. The post-test inspection confirmed no measurable degradation of the sliding sleeve tip 255 or housing seal 260 that would compromise the metal-to-metal sealing integrity across tubing and annulus when the flow control valve 200 is in the closed position. Therefore, the flow control valve 200 can confidently sustain the aforementioned pressure differentials across the flow trim for a minimum of 5 years, if not 10 years, if not 15 years, if not 20 years, if not 25 years, if not 27 years, in service without jeopardizing its pressure isolation capability, within the validated 27-year service life envelope.

Furthermore, in at least one embodiment, the size or position of the one or more flow trim ports 230 are configured to improve turbulence properties created as the subsurface fluids pass through the nearest most flow trim port 230a to prevent the housing seal 260 (e.g., metal-to-metal housing seal) from eroding while providing at least the 1.5 KSI pressure differential (e.g., if not at least 2.0 KSI, 2.5 KSI, or 3.0 KSI pressure differential). The turbulence properties, in one embodiment, may include the flow regime of the fluid flow, and whether the fluid flow is laminar or turbulent (e.g., as might be quantified by the dimensionless Reynolds number). The turbulence properties, in another embodiment, may additionally include the turbulence intensity, which is a measure of the intensity of the turbulent fluctuations in the fluid flow, and may be calculated using the root-mean-square of the velocity fluctuations and the mean velocity. In the present disclosure, a CFD analysis, along with a significant amount of experimentation, was employed to design the size or position of the one or more flow trim ports 230 to improve a turbulence created as the subsurface fluids pass through the nearest most flow trim port 230a to prevent the housing seal 260 (e.g., metal-to-metal housing seal) from eroding while providing at least the 1.5 KSI pressure differential. During the CFD evaluation, a semi-mechanistic erosion model with particle tracking was applied to assess fluid velocity distribution and particle impact behavior across the housing 210 and openings 220, the flow trim 225, sliding sleeve tip 255, and housing seal 260 under different pressure differentials (e.g., 1.5 KSI, 2.0 KSI, 2.5 KSI, and 3 KSI). The analysis focused on identifying regions of high velocity and turbulence that could lead to material loss. The design target was to maintain flow velocity below 70 ft/s, as velocities within this range minimize erosion on metallic components. The CFD results were further used to evaluate potential wear at the housing seal 260 (e.g., metal-to-metal housing seal) sealing surfaces. The geometry was considered acceptable when the predicted erosion depth remained below 0.002 in diametrically, confirming that the flow path design can withstand at least the 1.5 KSI pressure differential (e.g., if not at least 2.0 KSI, 2.5 KSI, or 3.0 KSI pressure differential) without compromising sealing integrity or structural performance.

In at least one embodiment, the improved turbulence properties are created by making sure that the nearest most flow trim port 230a is a distance (d) of at least 20 mm from the housing seal 260 (e.g., metal-to-metal housing seal). In yet another embodiment, the distance (d) is at least 40 mm from the housing seal 260 (e.g., metal-to-metal housing seal). In even yet another embodiment, the distance (d) is at least 60 mm from the housing seal 260 (e.g., metal-to-metal housing seal), if not at least 80 mm, 90 mm, 100 mm, 110, mm, 120 mm, 150 mm , 200 mm from the housing seal 260 (e.g., metal-to-metal housing seal). In at least one specific embodiment, such as wherein the nearest most flow trim port 230a prevents the housing seal 260 (e.g., metal-to-metal housing seal) from eroding while providing at least the 3.0 KSI pressure differential, the distance (d) is at least 63.5 mm. Again, this distance (d) may be instrumental in improving the turbulence properties, discussed above.

In at least one embodiment, the nearest most flow trim port 230a is one of a circumferential ring of multiple similar sized flow trim ports 230. The term similar sized, as used with regard to the flow trim ports, means that the area of the openings are within 10 percent of one another, which could be achieved with a larger width (w), length (l), or a combination of the two. In at least one other embodiment, the nearest most flow trim port 230a is one of a circumferential ring of multiple substantially similar sized flow trim ports 230. The term substantially similar sized, as used with regard to the flow trim ports, means that the area of the openings are within 5 percent of one another, which could be achieved with a larger width (w), length (l), or a combination of the two. In yet another embodiment, the nearest most flow trim port 230a is one of a circumferential ring of multiple ideally similar sized flow trim ports 230. The term ideally similar sized, as used with regard to the flow trim ports, means that the area of the openings are within 2 percent of one another, which could be achieved with a larger width (w), length (l), or a combination of the two. In yet another embodiment, the nearest most flow trim port 230a is one of a circumferential ring of multiple perfectly similar sized flow trim ports 230. The term perfectly similar sized, as used with regard to the flow trim ports, means that the area of the openings are within 0.5 percent of one another, which could be achieved with a larger width (w), length (l), or a combination of the two. For example, in at least one other embodiment, the circumferential ring of multiple similar sized flow trim ports is a first circumferential ring, and the flow trim 225 further including a second circumferential ring of multiple similar sized flow trim ports positioned further from the housing seal than the first circumferential ring. In one embodiment, the second ring of multiple similar sized flow trim ports are larger than the first ring of multiple similar sized ports. The term larger, as used with regard to the flow trim ports, means that the area of the opening is larger, which could be achieved with a larger width (w), length (l), or a combination of the two.

The flow control valve 200, in one or more embodiments, further includes an actuator 270 coupled with the sliding sleeve 250, the actuator 270 configured to move the sliding sleeve 250 between the first state and the second state. The actuator 270 may take on many different designs and remain within the scope of the disclosure. In at least one embodiment, however, the actuator 270 is an electric actuator configured to move the sliding sleeve 250 between the first state and the second state. In one or more embodiments, such as that shown, the electric actuator includes an electric motor 272, as well as a transmission 274 configured to covert the rotational motion of the electric motor 272 to the translation motion of sliding sleeve 250. In at least one embodiment, the transmission 274 is a ball screw transmission system, which converts the rotational motion of the electric motor 272 to the translation motion of the sliding sleeve 250. For example, in one or more embodiments, the ball screw transmission system includes a threaded ball nut 276 that threadingly engages with a threaded ball shaft 278 to convert the rotational motion of the electric motor 272 to the translation motion of the sliding sleeve 250. In the illustrated embodiment, the threaded ball nut 276 is rotationally coupled to the electric motor 272 and the threaded ball shaft 278 is positioned between the threaded ball nut 276 and the sliding sleeve 250, such that when the electric motor 272 rotates in one direction the sliding sleeve 250 linearly moves away from the housing seal 260 (e.g., metal-to-metal housing seal), and when the electric motor 272 rotates in an opposite direction the sliding sleeve 250 linearly moves toward the housing seal 260 (e.g., metal-to-metal housing seal). In yet another embodiment, however, the threaded ball shaft 278 is rotationally coupled to the electric motor 272 and the threaded ball nut 276 is positioned between the threaded ball shaft 278 and the sliding sleeve 250, such that when the electric motor 272 rotates in one direction the sliding sleeve 250 linearly moves away from the housing seal 260 (e.g., metal-to-metal housing seal), and when the electric motor 272 rotates in an opposite direction the sliding sleeve 250 linearly moves toward the housing seal 260 (e.g., metal-to-metal housing seal).

In at least one other embodiment, the flow control valve 200 further includes actuator electronics 280 coupled with the actuator 270. In at least one embodiment, the actuator electronics 280 include a network interface unit (NIU) module 280a, a power supply module 280b, and a motor control module 280c. In yet another embodiment, the actuator electronics 280 further includes a noise filter module 280d. The noise filter module 280d, in one or more embodiments, is configured to filter the communication lines from the electronic noise created by the operation of the flow control valve 200, that would otherwise disrupt an accuracy of the electronics (e.g., a position sensor, as discussed below) thereof. In at least one embodiment, the transmission line and the power source share the same conductor connecting upper completion and lower completion. Therefore, in such embodiments, noise generated by the actuator electronics 280 (such as from motor driving and/or non-linear regulators) during actuator 270 operation can interfere with the transmission line, reducing communication performance. The noise filter module 280d, in at least one embodiment, mitigates these effects by filtering out the noise.

In at least one embodiment, the actuator 270 is an actuator module positioned within a slot in a radial exterior surface of the housing 210. For example, the actuator module may be fixed within the slot of the housing using one or more actuator module retaining members 271.

In at least one other embodiment, the flow control valve 200 includes a position sensor 282 coupled with the sliding sleeve 250. In at least one embodiment, the position sensor 282 is configured to determine a change in a resistance value as the sliding sleeve 250 moves between the first state and the second state, the change in resistance value indicative of a position of the sliding sleeve 250 in relation to the first state and the second state. In one or more embodiments, the position sensor employs the equation V = I * R, wherein I supplied and known, R changes as the position sensor moves, and the output voltage provides the position of the sliding sleeve 250 in relation to the first state and the second state. In one or more embodiments, the position sensor 282 includes a sliding resistance structure 284, the sliding resistance structure 284 positioned within a track 286 and configured to slide in relation to (e.g., in lock step with) the sliding sleeve 250. For example, in at least one embodiment, the sliding resistance structure 284 includes one or more sliding resistance structure ferromagnetic features 288a and the sliding sleeve 250 includes one or more sliding sleeve ferromagnetic features 250a, and further wherein the one or more sliding resistance structure ferromagnetic features 288a and one or more sliding sleeve ferromagnetic features 250a magnetically couple together to slidingly fix the sliding resistance structure 284 and the sliding sleeve 250. In at least one embodiment, the position sensor 282 is configured to dynamically determine the change in the resistance value as the sliding sleeve 250 moves between the first state and the second state, the change in resistance value indicative of a dynamic position of the sliding sleeve in relation to the first state and the second state. Further to this embodiment, if the noise filter module 280d is used, it may filter electronic noise created by the operation of the flow control valve 200, that would otherwise disrupt an accuracy of the position sensor 282. Accordingly, the position sensor 282 in the disclosed embodiment is extremely accurate, and furthermore is not based upon turns of the electric motor 272 or transmission 274.

In yet another embodiment, the actuator 270 is a first actuator (e.g., first electric actuator), and the flow control valve 200 includes a second actuator 290 coupled with the sliding sleeve 250. In one embodiment, the actuator 270 and the second actuator 290 are configured to move the sliding sleeve 250 between the first state and the second state, but the actuator 270 and the second actuator 290 are configured such that only one of the actuator 270 and the second actuator 290 is operable to move the sliding sleeve 250 between the first state and the second state at a given moment in time. For example, in one embodiment, neither the actuator 270 nor the second actuator 290 are configured to interfere with the other of the second actuator 280 or actuator 270 that is (e.g., in the moment) operable to move the sliding sleeve 250. For example, in this embodiment the actuator 270 and the second actuator 290 are not operated in tandem (e.g., to provide additional translation force), but operated in lieu of (e.g., as a redundant actuator that may stay dormant for a period of time and then engage if/when the other actuator is not in operation). In at least one embodiment, the actuator 270 is a first electric actuator, and the second actuator 290 is a second electric actuator. In yet another embodiment, the actuator 270 is a first electric actuator, and the second actuator 290 is a second hydraulic actuator (e.g., second non-electric actuator or second hydro-electric actuator). In even yet another embodiment, the actuator 270 is a first hydraulic actuator (e.g., first non-electric actuator or first hydro-electric actuator), and the second actuator 290 is a second hydraulic actuator (e.g., second non-electric actuator or second hydro-electric actuator).

In accordance with one embodiment, the flow control valve 200 may further include a decoupling mechanism 292 positioned between the sliding sleeve 250 and the actuator 270 (or possibly between the sliding sleeve 250 and the second actuator 290 when used). The term “positioned between” as used herein means that it is located somewhere between the two to decouple the two, but does not mean directly between (e.g., unless otherwise stated). The decoupling mechanism 292, in this embodiment, is configured to allow the sliding sleeve 250 to move between the first state and the second state apart from an operation of the actuator 270 (or alternatively apart from an operation of the second actuator 290, when used). For instance, if the actuator 270 were to become inoperable, the decoupling mechanism 292 would allow the second actuator 290 to move the sliding sleeve 250 between the first state and the second state apart from an operation of the actuator 270. Alternatively, if the second actuator 290 were not in place and/or used, the decoupling mechanism 292 would allow a backup sliding mechanism (e.g., a wireline deployed shifting tool in one embodiment) to engage with a latch profile 294 on a radially inside surface of the sliding sleeve 250 to move the sliding sleeve 250 between the first state and the second state apart from an operation of the actuator 270 and/or second actuator 290 (e.g., if used).

The decoupling mechanism 292 may take on a number of different styles while remaining within the purview of the disclosure. In at least one embodiment, the decoupling mechanism 292 is a clutch 292a, the clutch 292a configured to allow the sliding sleeve 250 to move between the first state and the second state apart from an operation of the actuator 270 and/or second actuator 290 (e.g., if used). In this embodiment, the clutch 292a could be positioned between the electric motor 272 and the transmission 274, for example to allow the sliding sleeve to move between the first state and the second state apart from an operation of the actuator 270 and/or second actuator 290 (e.g., if used). In at least one other embodiment, the decoupling mechanism 292 is a shear feature 292b, the shear feature 292b configured to allow the sliding sleeve 250 to move between the first state and the second state apart from an operation of the actuator 270 and/or second actuator 290 (e.g., if used). In this embodiment, the shear feature 292b could be positioned between the transmission 274 and the sliding sleeve 250 (e.g., at a coupling point between the threaded shaft 278 or an extension thereof and the sliding sleeve 250), for example to allow the sliding sleeve to move between the first state and the second state apart from an operation of the actuator 270 and/or second actuator 290 (e.g., if used). In even yet another embodiment, the decoupling mechanism 292 is a backdrivability of one of the actuator 270 or the second actuator 290 (e.g., if used), the backdrivability configured to allow the sliding sleeve to move between the first state and the second state apart from an operation of the actuator 270 or the second actuator 290 (e.g., if used). Again, each of these decoupling mechanisms 292 may be used with or without the second actuator 290, and thus with or without the backup sliding mechanism discussed above.

The flow control valve 200, in one or more other embodiments, may include a pressure compensation bellows 296. The pressure compensation bellows 296, in one embodiment, is configured to provide pressure compensation between an interior compartment of the actuator 270, and the fluid thereabout. In at least one embodiment, the pressure compensation bellows 296 is filled with pressure compensation fluid.

Turning now to FIGS. 3 through 9, illustrated are various different embodiments of a clutch 300, as might be used along with the actuator 270 and second actuator 290 disclosed above. FIG. 3 is a partial cut-way view of one embodiment of a bi-directional overrunning clutch 300. The clutch 300 includes an input shaft 302 having a multi-surface profile 304 at a distal end thereof and an end journal 318 on an opposing end. The multi-surface profile 304 has a plurality of engagement surfaces 306. In the illustrated embodiments, the multi-surface profile is a hexagonal profile with six engagement surfaces 306, but other embodiments may have more or less engagement surfaces. Similarly, the end journal 318 may have a hexagonal shape or other shape. A clutch body 308 includes a cage 310 at a distal end thereof. The cage 310 may be positioned about the multi-surface profile 304. The cage may house a plurality of rollers 312 configured to engage the plurality of engagement surfaces 306 when the input shaft 302 rotates. An output shaft 314 is coupled with the clutch body 308 about the cage 310. When the input shaft 302 rotates, the plurality of rollers 312 engage the plurality of engagement surfaces 306 thereby transferring motion and torque to the output shaft 314 such that the output shaft 314 rotates in a same direction as the input shaft 302. The clutch 300 may have three operating modes: overrunning (may also be idle), clockwise, and counterclockwise, which will be illustrated and described in more detail in FIG. 4A through 4C.

The clutch 300 may use an anti-rotational friction force on the cage 310, which allows the input shaft 302 to automatically switch rotational direction. Some embodiments of the clutch 300 may also include a friction mechanism 320 positioned in an opening of a proximal end of the body 308. The friction mechanism 320 may be used to create the anti-rotational friction force to provide a resistance opposite to the rotating movement of the cage 310 until interference contact between the input shaft 302, rollers 312, and the output shaft 314 has been reached. The friction mechanism 320 may be generated by axial load and coefficient of friction. The axial load may be provided by different mechanisms, such as, for example, a helicoidal or Belleville Spring, magnets, interference contact with some bushing, etc.

Embodiments of the clutch 300 disclosed herein may provide an engagement system independently for each actuator. Embodiments of the clutch 300 may also withstand operating temperatures in a downhole environment between -18°C to 200°C and a pressurized environment of 20,000 psi. The clutch 300 may also operate even when submerged in a dielectric fluid or other oils, such that the clutch 300 and an actuator coupled with the clutch 300 may be chemical compatible while maintaining operational characteristics within the fluid, which may be exposed to a combination of pressure and temperatures. The clutch 300 may also provide high torque capability, and embodiments may provide both temporary and permanent disengagement capabilities for an actuator for which the clutch may be used as an engagement mechanism.

Referring now to FIG. 4A through 4C there is shown one embodiment of a bi-directional overrunning clutch 400 shown in different operating modes, an overrunning (or idle) mode and two engaged modes, clockwise (CW) and counterclockwise (CCW). The bi-directional overrunning clutch 400 is constructed similarly to clutch 300 and similar reference numbers are used to relate to similar features. FIG. 4A illustrates the clutch 400 in an overrunning (or idle) mode. In the overrunning mode, output shaft 414 rotates freely, in either a clockwise, or counterclockwise direction. The input shaft 402 does not rotate. As shown here, there is a clearance between rollers 412 positioned in cage 410 and both the output shaft 414 and a plurality of engagement surfaces 406 of an input shaft 402. As such, rollers 412 are not engaged with either the output shaft 414, or input shaft 402 and the rollers 412 are free rolling. In this condition the output shaft 414 can rotate freely without transferring any movement or torque to the input shaft 402. The rotation of the input shaft 402 enables the clutch 400 to either engage or disengage the actuator.

FIG. 4B illustrates the clutch 400 in the clockwise (CW) mode. As the input shaft 402 rotates, the rollers 412 contact and engage a first side of each of the plurality of engagement surface 406. When the input shaft 402 rotates, the rollers are free to move due to the clearance between the input shaft 402, rollers 412 and the output shaft 414. Progressing with the input shaft 402 rotation, the clearance decreases until the rollers 412 engage both the input shaft 402 and output shaft 414, engaging the clutch 400. Once the clutch 400 engages all components will rotate together. Once engaged, the rollers 412 are pushed outward into engagement with the output shaft 414, thereby transferring the CW motion and torque to the output shaft 414 such that the output shaft rotates in the CW direction and all components rotate together.

FIG. 4C illustrates the clutch 400 in the counterclockwise (CCW) mode. As the input shaft 402 rotates counterclockwise, the rollers 412 contact and engage the plurality of engagement surface 406. Once engaged, the rollers 412 rotate and are pushed outward into engagement with the output shaft 414, thereby transferring the CCW motion and torque to the output shaft 414 such that the output shaft rotates in the CCW direction and all components rotate together.

To ensure the engagement between the rollers 412 and the output shaft 414 and the input shaft 402, a resistance is created opposite to the rotational movement on the cage 410, until the interference contact between the input shaft 402 rollers 412, and the output shaft 414 is reached. The resistance could be a friction mechanism generated by axial load and coefficient of friction, such as the friction mechanism 320 as described.

Referring now to FIG. 5A through 5E, there are shown example components which may comprise clutch 300 or clutch 400 shown and described herein. FIG. 5A illustrates an embodiment of an input shaft 502 which includes a multi-surface profile 504 at a distal end thereof and a hexagonal journal 518 on the other end, however any different end journal as a square profile, a spline profile or a shaft with a key may be used. The multi-surface profile 504 has a plurality of engagement surfaces 506. FIG. 5B illustrates one embodiment of a clutch body 508, and more specifically a distal end of the body 508 having a cage 510 for housing a plurality of rollers therein. FIG. 5C illustrates one embodiment of a roller 512 which may be positioned in the cage 510 and engage the engagement surfaces 506 of the input shaft 502.

FIG. 5D illustrates one embodiment of an output shaft 514 which may couple onto the distal end of the clutch body 508 (FIG. 5B) and about the cage 510 (FIG. 5B). The output shaft 514 may include openings 516 for receiving fasteners of a transmission shaft which may be coupled thereto or any different end journal as a square, hexagonal or even a spline profile or a shaft with a key. FIG. 5E illustrates one embodiment of a friction mechanism 520 which may be used with clutch 300. The illustrated friction mechanism 520 is a spring, however it can use any other friction system such as, for example, a helicoidal or Belleville spring, magnets, interference contact with some bushing, etc.

Referring now to FIG. 6, there is shown one embodiment of an EDB actuator 600 that may be coupled with and used to actuate a target component within a wellbore. The EDB actuator 600 may include a housing 602 including an electric motor 604. The actuator may also include a mechanism to transform linear displacement into rotation, such as a ball nut 610 and ball-screw 612 in this embodiment, transforming rotation into linear displacement and vice-versa, depending on operation mode. An engagement system 606 is coupled with the motor 604 and the ball nut 610 and ball-screw 612 and is configured to both engage and disengage the ball-screw 612 and nut 610. The ball screw 612 comprises a slide rod 614 which may couple with the target component. The ball nut 610 may be supported by a thrust bearing 616. The housing 602 may include at least one inner chamber 618 which may contain a lubricant and/or dielectric oil. As the oil is compressed and expanded by pressure and temperature, the volume change or displacement of the oil may be compensated by at least one compensator 620 fluidly connected with the inner chamber 618. The compensator 620 may include at least one of a bellows, a piston, a bladder, or diaphragm components. In some embodiments, a dynamic sealing system 622 may be positioned in one end of the housing 602 to seal the inner chamber 618 from the external environment in the wellbore (such as the annulus or tubing). In some embodiments, the inner chamber 618 may also include a rotating seal 624 to provide additional sealing to protect against contamination of the oil where electrical components are placed.

When the motor 604 rotates in either a clockwise or counterclockwise direction. The engagement system 606, ball nut 610 and ball screw 612 also rotate and thus the slide rod 614 is extended further from, or retracted toward the actuator housing 602, thereby pushing or pulling on the target components which may be a valve, or another target component. In this embodiment, the engagement system 606 may comprise a bi-directional overrunning clutch such as clutch 300 or 400 discussed above.

In other embodiments, the engagement system 606 may comprise a free-wheeling hub that applies torque in a first direction from the motor 604 toward the ball nut 610 to transform rotation into linear displacement, but then the freewheeling hub rotates freely when torque is applied in a second direction from the ball nut toward the motor. In other embodiments, the engagement system 608 may comprise a two-way ratchet clutch acting in the same way as explained for two-way clutch and free-wheeling hub.

In still another embodiment, the ball-screw 612 and ball nut 610 may be replaced with a planetary roller screw and nut, and may be engaged by the engagement system 608, which may be a bi-directional overrunning clutch such as clutch 300, or a free-wheeling hub, or a two-way ratchet clutch.

Referring now to FIG. 7, there is shown another embodiment of an EDB actuator 700 according to some embodiments. The EDB actuator 700 is similar to EDB actuator 600 but may an inner chamber 718 of housing 702 may be fluidly coupled with a first compensator 720 and a second compensator 721 to compensate for volume change or displacement of oil/dielectric oil in the inner chamber 718 as the oil is compressed and expanded by pressure and temperature.

Embodiments of the Bi-directional Overrunning Clutch and EDB actuator disclosed herein may be used in several downhole applications and situations. Embodiments of the clutch/engagement system and EDB actuator may be used when a redundancy system is required, such as in FIG. 8A and 8B and/or suitable for field intervention if needed, such as illustrated in FIG. 9.

Referring now to FIG. 8A , there is shown an example of a bi-directional overrunning clutch used as an engagement system with a downhole target mechanism, when one redundant actuator is used. In this example when required to run the Actuator, Motor 1, Motor 2 is turned off and disengaged from Ball Nut 2 by Clutch 2, so Motor 1 is able to move the required load (related to actuating the downhole target mechanism) without jeopardizing, stressing, or moving the Motor 2. These downhole systems may include two or more actuators. In FIG. 8A, the main actuator is activated and the main motor, Motor 1, is ON. The redundant actuator is in overrunning mode, and the redundant motor (e.g., Motor 2) is OFF. This system is able to push and pull the load with the ball screw of the main actuator.

Referring now to FIG. 8B, there is shown another example of a bi-directional overrunning clutch used as an engagement system with a downhole target mechanism when one redundant actuator is used. In this example when required to run the Actuator, Motor 2, the Motor 1 is turned off and disengaged from Ball Nut 1 by Clutch 1, so Motor 2 is able to move the required load (related to actuating the downhole target mechanism) without jeopardizing, stressing, or moving the Motor 1. These downhole systems may include two or more actuators. In FIG. 8B, the main actuator is in overrunning mode and the main, Motor 1, is OFF. The redundant actuator is activated and the redundant motor, Motor 2 is ON. This system is able to push and pull the load with the ball screw of the redundant actuator. In some other examples, both Motor 1 and Motor 2 may operate together.

Referring now to FIG. 9, there is shown an example of a bi-directional overrunning clutch used as an engagement system when an intervention may be required to operate a target mechanism positioned downhole, such as e.g., a valve. The system includes a main actuator and a redundant actuator. Both the main and redundant actuators and the motors are OFF, and the Load can be applied through an intervention tool without any transfer or movement of the main and redundant motors. In this scenario both engagement systems of the actuators will be in the overrunning mode (idle position). Once the intervention tool has completed the required actuation, the intervention tool may be removed, and the main and redundant actuators and motors may maintain their normal functions and can be used for further actuation as required (as shown and discussed in FIG. 8A and 8B). Insertion of an intervention tool may be triggered by manual user intervention or may be triggered upon review of measurements taken from downhole tools that indicate intervention may be needed.

### Aspects disclosed herein include:

A. A flow control valve, the flow control valve including: 1) a housing including a central bore extending axially there through, the central bore configured to convey subsurface fluids there through; 2) an opening located in a sidewall of the housing; 3) a flow trim coupled with the housing and covering the opening, the flow trim including one or more flow trim ports configured to allow the subsurface fluids to pass between the housing and a subterranean formation surrounding the housing; 4) a sliding sleeve disposed in the central bore of the housing, the sliding sleeve configured to move between a first state covering the one or more flow trim ports and engaging a metal-to-metal seal and second state disengaging from the metal-to-metal seal and exposing at least a portion of the one or more flow trim ports; and 5) an electric actuator coupled with the sliding sleeve, the electric actuator configured to move the sliding sleeve between the first state and the second state.

B. A method, the method including: 1) positioning a downhole tool within a wellbore extending through one or more subterranean formations, the downhole tool having a flow control valve, including: a) a housing including a central bore extending axially there through, the central bore configured to convey subsurface fluids there through; b) an opening located in a sidewall of the housing; c) a flow trim coupled with the housing and covering the opening, the flow trim including one or more flow trim ports configured to allow the subsurface fluids to pass between the housing and a subterranean formation surrounding the housing; d) a sliding sleeve disposed in the central bore of the housing, the sliding sleeve configured to move between a first state covering the one or more flow trim ports and engaging a metal-to-metal seal and second state disengaging from the metal-to-metal seal and exposing at least a portion of the one or more flow trim ports; and e) an electric actuator coupled with the sliding sleeve, the electric actuator configured to move the sliding sleeve between the first state and the second state; and 2) actuating the sliding sleeve between the first state and the second state.

C. A well system, the well system including: 1) a wellbore extending through one or more subterranean formations; and 2) a downhole tool located within the wellbore, the downhole tool having a flow control valve including: a) a housing including a central bore extending axially there through, the central bore configured to convey subsurface fluids there through; b) an opening located in a sidewall of the housing; c) a flow trim coupled with the housing and covering the opening, the flow trim including one or more flow trim ports configured to allow the subsurface fluids to pass between the housing and a subterranean formation surrounding the housing; d) a sliding sleeve disposed in the central bore of the housing, the sliding sleeve configured to move between a first state covering the one or more flow trim ports and engaging a metal-to-metal seal and second state disengaging from the metal-to-metal seal and exposing at least a portion of the one or more flow trim ports; and e) an electric actuator coupled with the sliding sleeve, the electric actuator configured to move the sliding sleeve between the first state and the second state.

D. A flow control valve, the flow control valve including: 1) a housing including a central bore extending axially there through, the central bore configured to convey subsurface fluids there through; 2) an opening located in a sidewall of the housing; 3) a flow trim coupled with the housing and covering the opening, the flow trim including one or more flow trim ports configured to allow the subsurface fluids to pass between the housing and a subterranean formation surrounding the housing; and 4) a sliding sleeve disposed in the central bore of the housing, the sliding sleeve configured to move between a first state covering the one or more flow trim ports and engaging a housing seal and second state disengaging from the housing seal and exposing at least a portion of the one or more flow trim ports, wherein a size or position of the one or more flow trim ports are configured to prevent the housing seal from eroding while providing at least a 1.5 KSI pressure differential between an outside of the housing and the central bore as the sliding sleeve moves past a nearest most flow trim port to the housing seal.

E. A method, the method including: 1) positioning a downhole tool within a wellbore extending through one or more subterranean formations, the downhole tool having a flow control valve, including: a) a housing including a central bore extending axially there through, the central bore configured to convey subsurface fluids there through; b) an opening located in a sidewall of the housing; c) a flow trim coupled with the housing and covering the opening, the flow trim including one or more flow trim ports configured to allow the subsurface fluids to pass between the housing and a subterranean formation surrounding the housing; and d) a sliding sleeve disposed in the central bore of the housing, the sliding sleeve configured to move between a first state covering the one or more flow trim ports and engaging a housing seal and second state disengaging from the housing seal and exposing at least a portion of the one or more flow trim ports, wherein a size or position of the one or more flow trim ports are configured to prevent the housing seal from eroding while providing at least a 1.5 KSI pressure differential between an outside of the housing and the central bore as the sliding sleeve moves past a nearest most flow trim port to the housing seal; and 2) actuating the sliding sleeve between the first state and the second state.

F. A well system, the well system: 1) a wellbore extending through one or more subterranean formations; and 2) a downhole tool located within the wellbore, the downhole tool having a flow control valve including: a) a housing including a central bore extending axially there through, the central bore configured to convey subsurface fluids there through; b) an opening located in a sidewall of the housing; c) a flow trim coupled with the housing and covering the opening, the flow trim including one or more flow trim ports configured to allow the subsurface fluids to pass between the housing and a subterranean formation surrounding the housing; and d) a sliding sleeve disposed in the central bore of the housing, the sliding sleeve configured to move between a first state covering the one or more flow trim ports and engaging a housing seal and second state disengaging from the housing seal and exposing at least a portion of the one or more flow trim ports, wherein a size or position of the one or more flow trim ports are configured to prevent the housing seal from eroding while providing at least a 1.5 KSI pressure differential between an outside of the housing and the central bore as the sliding sleeve moves past a nearest most flow trim port to the housing seal.

G. A flow control valve, the flow control valve including: 1) a housing including a central bore extending axially there through, the central bore configured to convey subsurface fluids there through; 2) an opening located in a sidewall of the housing; 3) a flow trim coupled with the housing and covering the opening, the flow trim including one or more flow trim ports configured to allow the subsurface fluids to pass between the housing and a subterranean formation surrounding the housing; 4) a sliding sleeve disposed in the central bore of the housing, the sliding sleeve configured to move between a first state covering the one or more flow trim ports and engaging a housing seal and second state disengaging from the housing seal and exposing at least a portion of the one or more flow trim ports; and 5) a position sensor coupled with the sliding sleeve, the position sensor configured to determine a change in a resistance value as the sliding sleeve moves between the first state and the second state, the change in resistance value indicative of a position of the sliding sleeve in relation to the first state and the second state.

H. A method, the method including: 1) positioning a downhole tool within a wellbore extending through one or more subterranean formations, the downhole tool having a flow control valve, including: a) a housing including a central bore extending axially there through, the central bore configured to convey subsurface fluids there through; b) an opening located in a sidewall of the housing; c) a flow trim coupled with the housing and covering the opening, the flow trim including one or more flow trim ports configured to allow the subsurface fluids to pass between the housing and a subterranean formation surrounding the housing; d) a sliding sleeve disposed in the central bore of the housing, the sliding sleeve configured to move between a first state covering the one or more flow trim ports and engaging a housing seal and second state disengaging from the housing seal and exposing at least a portion of the one or more flow trim ports; and e) a position sensor coupled with the sliding sleeve, the position sensor configured to determine a change in a resistance value as the sliding sleeve moves between the first state and the second state, the change in resistance value indicative of a position of the sliding sleeve in relation to the first state and the second state; and 2) actuating the sliding sleeve between the first state and the second state.

I. A well system, the well system including: 1) a wellbore extending through one or more subterranean formations; and 2) a downhole tool located within the wellbore, the downhole tool having a flow control valve including: a) a housing including a central bore extending axially there through, the central bore configured to convey subsurface fluids there through; b) an opening located in a sidewall of the housing; c) a flow trim coupled with the housing and covering the opening, the flow trim including one or more flow trim ports configured to allow the subsurface fluids to pass between the housing and a subterranean formation surrounding the housing; d) a sliding sleeve disposed in the central bore of the housing, the sliding sleeve configured to move between a first state covering the one or more flow trim ports and engaging a housing seal and second state disengaging from the housing seal and exposing at least a portion of the one or more flow trim ports; and e) a position sensor coupled with the sliding sleeve, the position sensor configured to determine a change in a resistance value as the sliding sleeve moves between the first state and the second state, the change in resistance value indicative of a position of the sliding sleeve in relation to the first state and the second state.

J. A flow control valve, the control valve including: 1) a housing including a central bore extending axially there through, the central bore configured to convey subsurface fluids there through; 2) an opening located in a sidewall of the housing; 3) a flow trim coupled with the housing and covering the opening, the flow trim including one or more flow trim ports configured to allow the subsurface fluids to pass between the housing and a subterranean formation surrounding the housing; and 4) a sliding sleeve disposed in the central bore of the housing, the sliding sleeve configured to move between a first state covering the one or more flow trim ports and engaging a housing seal and second state disengaging from the housing seal and exposing at least a portion of the one or more flow trim ports; and 5) first and second actuators coupled with the sliding sleeve, the first and second actuators configured to move the sliding sleeve between the first state and the second state, and further wherein the first and second actuators are configured such that only one of the first or second actuator is operable move the sliding sleeve between the first state and the second state at a given moment in time.

K. A method, the method including: 1) positioning a downhole tool within a wellbore extending through one or more subterranean formations, the downhole tool having a flow control valve, including: a) a housing including a central bore extending axially there through, the central bore configured to convey subsurface fluids there through; b) an opening located in a sidewall of the housing; c) a flow trim coupled with the housing and covering the opening, the flow trim including one or more flow trim ports configured to allow the subsurface fluids to pass between the housing and a subterranean formation surrounding the housing; d) a sliding sleeve disposed in the central bore of the housing, the sliding sleeve configured to move between a first state covering the one or more flow trim ports and engaging a housing seal and second state disengaging from the housing seal and exposing at least a portion of the one or more flow trim ports; and e) first and second actuators coupled with the sliding sleeve, the first and second actuators configured to move the sliding sleeve between the first state and the second state, and further wherein the first and second actuators are configured such that only one of the first or second actuator is operable move the sliding sleeve between the first state and the second state at a given moment in time; and 2) actuating the sliding sleeve between the first state and the second state.

L. A well system, the well system including: 1) a wellbore extending through one or more subterranean formations; and 2) a downhole tool located within the wellbore, the downhole tool having a flow control valve including: a) a housing including a central bore extending axially there through, the central bore configured to convey subsurface fluids there through; b) an opening located in a sidewall of the housing; c) a flow trim coupled with the housing and covering the opening, the flow trim including one or more flow trim ports configured to allow the subsurface fluids to pass between the housing and a subterranean formation surrounding the housing; d) a sliding sleeve disposed in the central bore of the housing, the sliding sleeve configured to move between a first state covering the one or more flow trim ports and engaging a housing seal and second state disengaging from the housing seal and exposing at least a portion of the one or more flow trim ports; and e) first and second actuators coupled with the sliding sleeve, the first and second actuators configured to move the sliding sleeve between the first state and the second state, and further wherein the first and second actuators are configured such that only one of the first or second actuator is operable move the sliding sleeve between the first state and the second state at a given moment in time.

Aspects A through L may have one or more of the following additional elements in combination: Element 1: wherein the metal-to-metal seal is an interference fit metal-to-metal seal. Element 2: wherein an interior radial surface of the interference fit metal-to-metal seal includes one or more seal nubs configured to engage with the sliding sleeve when the sliding sleeve is in the first state. Element 3: wherein a size or position of the one or more flow trim ports are configured to prevent the metal-to-metal seal from eroding while providing at least a 1.5 KSI pressure differential between an outside of the housing and the central bore as the sliding sleeve moves past a nearest most flow trim port to the metal-to-metal seal. Element 4: wherein the one or more flow trim ports are configured to prevent the metal-to-metal seal from eroding while providing at least a 2.0 KSI pressure differential. Element 5: wherein the one or more flow trim ports are configured to prevent the metal-to-metal seal from eroding while providing at least a 2.5 KSI pressure differential. Element 6: wherein the one or more flow trim ports are configured to prevent the metal-to-metal seal from eroding while providing at least a 3.0 KSI pressure differential. Element 7: wherein the size or position of the one or more flow trim ports are configured to improve turbulence properties created as the subsurface fluids pass through the nearest most flow trim port to prevent the metal-to-metal seal from eroding while providing at least the 1.5 KSI pressure differential. Element 8: wherein the nearest most flow trim port is a distance (d) of at least 60 mm from the metal-to-metal seal. Element 9: further including a decoupling mechanism positioned between the sliding sleeve and the electric actuator, the decoupling mechanism configured to allow the sliding sleeve to move between the first state and the second state apart from an electric operation of the electric actuator. Element 10: wherein the one or more flow trim ports are configured to prevent the housing seal from eroding while providing at least a 2.0 KSI pressure differential. Element 11: wherein the one or more flow trim ports are configured to prevent the housing seal from eroding while providing at least a 2.5 KSI pressure differential. Element 12: wherein the one or more flow trim ports are configured to prevent the housing seal from eroding while providing at least a 3.0 KSI pressure differential. Element 13: wherein the size or position of the one or more flow trim ports are configured to improve turbulence properties created as the subsurface fluids pass through the nearest most flow trim port to prevent the housing seal from eroding while providing at least the 1.5 KSI pressure differential. Element 14: wherein the nearest most flow trim port is one of a circumferential ring of multiple similar sized flow trim ports. Element 15: wherein the circumferential ring of multiple similar sized flow trim ports is a first circumferential ring, and further including a second circumferential ring of multiple similar sized flow trim ports positioned further from the housing seal than the first circumferential ring, wherein the second ring of multiple similar sized flow trim ports are larger than the first ring of multiple similar sized ports. Element 16: wherein the nearest most flow trim port is a distance (d) of at least 60 mm from the housing seal. Element 17: wherein the housing seal is a metal-to-metal seal. Element 18: further including an electric actuator coupled with the sliding sleeve, the electric actuator configured to move the sliding sleeve between the first state and the second state. Element 19: wherein the position sensor includes a sliding resistance structure, the sliding resistance structure positioned within a track and configured to slide in relation to the sliding sleeve. Element 20: wherein the sliding resistance structure includes one or more sliding resistance structure ferromagnetic features and the sliding sleeve includes one or more sliding sleeve ferromagnetic features, and further wherein the one or more sliding resistance structure ferromagnetic features and one or more sliding sleeve ferromagnetic features magnetically couple together to slidingly fix the sliding sleeve and the sliding resistance structure. Element 21: wherein the position sensor is configured to dynamically determine the change in the resistance value as the sliding sleeve moves between the first state and the second state, the change in resistance value indicative of a dynamic position of the sliding sleeve in relation to the first state and the second state. Element 22: further including an electric actuator coupled with the sliding sleeve, the electric actuator configured to move the sliding sleeve between the first state and the second state. Element 23: further including actuator electronics coupled with the actuator, the actuator electronics including a noise filter module configured to filter electronic noise created by the operation of the flow control valve that would otherwise disrupt an accuracy of the position sensor. Element 24: wherein the actuator electronics further includes a network interface unit module, a power supply module, and a motor control module. Element 25: wherein a size or position of the one or more flow trim ports are configured to prevent the housing seal from eroding while providing at least a 1.5 KSI pressure differential between an outside of the housing and the central bore as the sliding sleeve moves past a nearest most flow trim port to the housing seal. Element 26: wherein the size or position of the one or more flow trim ports are configured to improve turbulence properties created as the subsurface fluids pass through the nearest most flow trim port to prevent the housing seal from eroding while providing at least the 1.5 KSI pressure differential. Element 27: wherein the housing seal is a metal-to-metal seal. Element 28: wherein the first actuator is a first electric actuator. Element 29: wherein the second actuator is a second electric actuator. Element 30: wherein the second actuator is a second hydraulic actuator. Element 31: wherein the second hydraulic actuator is a second non-electric actuator. Element 32: further including a decoupling mechanism positioned between the sliding sleeve and the first actuator or the sliding sleeve and the second actuator, the decoupling mechanism configured to allow the sliding sleeve to move between the first state and the second state apart from an operation of an other of the second actuator or the first actuator. Element 33: wherein the decoupling mechanism is a clutch, the clutch configured to allow the sliding sleeve to move between the first state and the second state apart from an operation of an other of the second actuator or the first actuator. Element 34: wherein the decoupling mechanism is a shear feature, the shear feature configured to allow the sliding sleeve to move between the first state and the second state apart from an operation of an other of the second actuator or the first actuator. Element 35: wherein the decoupling mechanism is a backdrivability of one of the first actuator or the second actuator, the backdrivability configured to allow the sliding sleeve to move between the first state and the second state apart from an operation of an other of the second actuator or the first actuator. Element 36: wherein a radially inside surface of the sliding sleeve includes a latch profile, the latch profile configured to allow a backup sliding mechanism to engage with the sliding sleeve and move the sliding sleeve between the first state and the second state apart from an operation of the first actuator or the second actuator.

Those skilled in the art to which this application relates will appreciate that other and further additions, deletions, substitutions, and modifications may be made to the described embodiments.

What is claimed is:

1. A flow control valve, comprising:
a housing including a central bore extending axially there through, the central bore configured to convey subsurface fluids there through;
an opening located in a sidewall of the housing;
a flow trim coupled with the housing and covering the opening, the flow trim including one or more flow trim ports configured to allow the subsurface fluids to pass between the housing and a subterranean formation surrounding the housing;
a sliding sleeve disposed in the central bore of the housing, the sliding sleeve configured to move between a first state covering the one or more flow trim ports and engaging a metal-to-metal seal and second state disengaging from the metal-to-metal seal and exposing at least a portion of the one or more flow trim ports; and
an electric actuator coupled with the sliding sleeve, the electric actuator configured to move the sliding sleeve between the first state and the second state.

2. The flow control valve as recited in claim 1, wherein the metal-to-metal seal is an interference fit metal-to-metal seal.

3. The flow control valve as recited in claim 2, wherein an interior radial surface of the interference fit metal-to-metal seal includes one or more seal nubs configured to engage with the sliding sleeve when the sliding sleeve is in the first state.

4. The flow control valve as recited in claim 1, wherein a size or position of the one or more flow trim ports are configured to prevent the metal-to-metal seal from eroding while providing at least a 1.5 KSI pressure differential between an outside of the housing and the central bore as the sliding sleeve moves past a nearest most flow trim port to the metal-to-metal seal.

5. The flow control valve as recited in claim 4, wherein the one or more flow trim ports are configured to prevent the metal-to-metal seal from eroding while providing at least a 2.0 KSI pressure differential.

6. The flow control valve as recited in claim 4, wherein the one or more flow trim ports are configured to prevent the metal-to-metal seal from eroding while providing at least a 2.5 KSI pressure differential.

7. The flow control valve as recited in claim 4, wherein the one or more flow trim ports are configured to prevent the metal-to-metal seal from eroding while providing at least a 3.0 KSI pressure differential.

8. The flow control valve a recited in claim 4, wherein the size or position of the one or more flow trim ports are configured to improve turbulence properties created as the subsurface fluids pass through the nearest most flow trim port to prevent the metal-to-metal seal from eroding while providing at least the 1.5 KSI pressure differential.

9. The flow control valve as recited in claim 4, wherein the nearest most flow trim port is a distance (d) of at least 60 mm from the metal-to-metal seal.

10. The flow control valve as recited in claim 1, further including a decoupling mechanism positioned between the sliding sleeve and the electric actuator, the decoupling mechanism configured to allow the sliding sleeve to move between the first state and the second state apart from an electric operation of the electric actuator.

11. A method, comprising:
positioning a downhole tool within a wellbore extending through one or more subterranean formations, the downhole tool having a flow control valve, including:
a housing including a central bore extending axially there through, the central bore configured to convey subsurface fluids there through;
an opening located in a sidewall of the housing;
a flow trim coupled with the housing and covering the opening, the flow trim including one or more flow trim ports configured to allow the subsurface fluids to pass between the housing and a subterranean formation surrounding the housing;
a sliding sleeve disposed in the central bore of the housing, the sliding sleeve configured to move between a first state covering the one or more flow trim ports and engaging a metal-to-metal seal and second state disengaging from the metal-to-metal seal and exposing at least a portion of the one or more flow trim ports; and
an electric actuator coupled with the sliding sleeve, the electric actuator configured to move the sliding sleeve between the first state and the second state; and
actuating the sliding sleeve between the first state and the second state.

12. The method as recited in claim 11, wherein the metal-to-metal seal is an interference fit metal-to-metal seal.

13. The method as recited in claim 12, wherein an interior radial surface of the interference fit metal-to-metal seal includes one or more seal nubs configured to engage with the sliding sleeve when the sliding sleeve is in the first state.

14. The method as recited in claim 11, wherein a size or position of the one or more flow trim ports are configured to prevent the metal-to-metal seal from eroding while providing at least a 1.5 KSI pressure differential between an outside of the housing and the central bore as the sliding sleeve moves past a nearest most flow trim port to the metal-to-metal seal.

15. The method as recited in claim 14, wherein the one or more flow trim ports are configured to prevent the metal-to-metal seal from eroding while providing at least a 2.0 KSI pressure differential.

16. The method as recited in claim 14, wherein the one or more flow trim ports are configured to prevent the metal-to-metal seal from eroding while providing at least a 2.5 KSI pressure differential.

17. The method as recited in claim 14, wherein the one or more flow trim ports are configured to prevent the metal-to-metal seal from eroding while providing at least a 3.0 KSI pressure differential.

18. The method a recited in claim 14, wherein the size or position of the one or more flow trim ports are configured to improve turbulence properties created as the subsurface fluids pass through the nearest most flow trim port to prevent the metal-to-metal seal from eroding while providing at least the 1.5 KSI pressure differential.

19. The method as recited in claim 14, wherein the nearest most flow trim port is a distance (d) of at least 60 mm from the metal-to-metal seal.

20. The method as recited in claim 11, further including a decoupling mechanism positioned between the sliding sleeve and the electric actuator, the decoupling mechanism configured to allow the sliding sleeve to move between the first state and the second state apart from an electric operation of the electric actuator.

21. A well system, comprising:
a wellbore extending through one or more subterranean formations; and
a downhole tool located within the wellbore, the downhole tool having a flow control valve including:
a housing including a central bore extending axially there through, the central bore configured to convey subsurface fluids there through;
an opening located in a sidewall of the housing;
a flow trim coupled with the housing and covering the opening, the flow trim including one or more flow trim ports configured to allow the subsurface fluids to pass between the housing and a subterranean formation surrounding the housing;
a sliding sleeve disposed in the central bore of the housing, the sliding sleeve configured to move between a first state covering the one or more flow trim ports and engaging a metal-to-metal seal and second state disengaging from the metal-to-metal seal and exposing at least a portion of the one or more flow trim ports; and
an electric actuator coupled with the sliding sleeve, the electric actuator configured to move the sliding sleeve between the first state and the second state.
